(19) United States
(12) Patent Application Publication
(10) Pub. No.: US 2024/0093749 A1
(43) Pub. Date: Mar. 21, 2024

(54) BICYCLE SUSPENSION COMPONENTS

(71) Applicant: SRAM, LLC, CHICAGO, IL (US)

(72) Inventors: DAVID CAMP, COLORADO SPRINGS, CO (US); BRONSON STAGNER, COLORADO SPRINGS, CO (US)

(73) Assignee: SRAM, LLC, CHICAGO, IL (US)

(21) Appl. No.: 18/333,691

(22) Filed: Jun. 13, 2023

Related U.S. Application Data
(63) Continuation-in-part of application No. 17/947,315, filed on Sep. 19, 2022.

(51) Int. Cl. F16F 9/06; F16F 9/348

(52) U.S. Cl. CPC F16F 9/067; F16F 9/3485

(57) ABSTRACT

Bicycle suspension components are described herein. An example damper for a bicycle suspension component includes a damper body defining a chamber and a damper member disposed in the chamber. The damper member includes a piston having a first compression port and a bypass compression port. The damper member includes a first valve to control fluid flow through the first compression port and a second valve to control fluid flow through the bypass compression port. During a first portion of travel of the damper member during a compression stroke, the second valve is to open to enable fluid flow through the bypass compression port from a first chamber to a second chamber, and during a second portion of travel of the damper member during the compression stroke, the first valve is to open to enable fluid flow through the first compression port from the first chamber to the second chamber.

### RELATED APPLICATION

This patent arises from a continuation-in-part of U.S. application Ser. No. 17/947,315, titled “Bicycle Suspension Components,” filed Sep. 19, 2022. U.S. application Ser. No. 17/947,315 is hereby incorporated by referenced in its entirety. Priority to U.S. application Ser. No. 17/947,315 is hereby claimed.

### FIELD OF THE DISCLOSURE

This disclosure relates generally to bicycle components and, more specifically, to bicycle suspension components.

### BACKGROUND

Bicycles are known to have suspension components. Suspension components are used for various applications, such as cushioning impacts, vibrations, or other disturbances experienced by the bicycle during use as well as maintaining ground contact for traction. A common application for suspension components on bicycles is cushioning impacts or vibrations experienced by the rider when the bicycle is ridden over bumps, ruts, rocks, potholes, and/or other obstacles. These suspension components include rear and/or front wheel suspension components. Suspension components may also be used in other locations, such as a seat post or handlebar, to insulate the rider from impacts.

### SUMMARY

Disclosed herein is an example damper for a suspension component of a bicycle. The damper includes a damper body defining a chamber, a shaft extending into the damper body, and a damper member disposed in the chamber and coupled to the shaft. The damper member divides the chamber into a first chamber and a second chamber. The damper member includes a piston having a primary compression port and a bypass compression port. The damper member includes a first valve to control fluid flow through the primary compression port and a second valve to control fluid flow through the bypass compression port. During a first portion of travel of the damper member during a compression stroke, the second valve is to open to enable fluid flow through the bypass compression port from the first chamber to the second chamber, and during a second portion of travel of the damper member during the compression stroke, the first valve is to open to enable fluid flow through the primary compression port from the first chamber to the second chamber.

Disclosed herein is an example damper for a suspension component of a bicycle. The damper includes a damper body defining a chamber. The chamber has a first section with a first cross-sectional area and a second section with a second cross-sectional area greater than the first cross-sectional area. The damper also includes a shaft extending into the damper body and a damper member disposed in the chamber and coupled to the shaft. The damper member divides the chamber into a first chamber and a second chamber. The damper member includes a piston having a plurality of radial openings, a first seal around the piston, and a second seal around the piston. The radial openings are axially spaced between the first and second seals. During a first portion of travel of the damper member during a compression stroke, the first seal is engaged with an inner surface of the damper body along the first section of the chamber and the second seal is spaced from the inner surface of the damper body along the second section of the chamber to enable fluid flow through the radial openings from the first chamber to the second chamber. During a second portion of travel of the damper member during the compression stroke, the first and second seals are engaged with the inner surface along the first section of the chamber to prevent fluid flow through the radial openings from the first chamber to the second chamber.

Disclosed herein is an example damper for a suspension component of a bicycle. The damper includes a damper body, a shaft extending into the damper body, a damper member disposed in the damper body and coupled to the shaft, the damper member including a piston sealingly engaged with an inner surface of the damper body to divide the damper body into a first chamber and a second chamber, first means for allowing fluid flow across the piston from the first chamber to the second chamber during a first portion of travel of the damper member during a compression stroke, and second means for allowing fluid flow across the piston from the first chamber to the second chamber during a second portion of travel of the damper member during the compression stroke.

Disclosed herein is an example damper for a suspension component of a bicycle. The damper includes a damper body defining a chamber, a shaft extending into the damper body, and a damper member disposed in the chamber and coupled to the shaft. The damper member divides the chamber into a first chamber and a second chamber. The damper member includes a piston including a disc and a wall extending from the disc. A portion of an outer surface of the wall is sealed with an inner surface of the damper body. The piston has a radial opening extending through the wall. The damper member also includes a radial flow shim disposed on an outer surface of the wall of the piston over the radial opening. The radial flow shim is flexible such that during at least a portion of travel of the damper member during a compression stroke, a portion of the radial flow shim is flexed away from the outer surface of the wall to enable fluid flow through the radial opening from the first chamber to the second chamber.

Disclosed herein is an example damper for a suspension component of a bicycle. The damper comprises a damper body defining a chamber, a shaft extending into the damper body, and a damper member disposed in the chamber. The damper member includes a piston including a wall forming a cavity. The piston has a radial opening extending through the wall between an inner surface of the wall and an outer surface of the wall. The damper member also includes a radial flow shim coupled to the wall and covering the opening. The radial flow shim is oriented perpendicular to a radial line extending from an axis of movement of the damper member.

### BRIEF DESCRIPTION OF THE DRAWINGS

FIG. 1 is a side view of an example bicycle that may employ example suspension components disclosed herein.

FIG. 2 is a schematic diagram of an example damper that may be implemented on the example bicycle of FIG. 1.

FIG. 3 is an enlarged view of the callout in FIG. 2 showing an example damper member of the example damper.

FIG. 4 illustrates the example damper member of FIG. 3 showing a first compression flow path during a first portion of travel of the example damper member during a compression stroke.

FIG. 5 illustrates the example damper member of FIG. 3 showing a second compression flow path during a second portion of travel of the example damper member during a compression stroke.

FIG. 6 illustrates the example damper of FIG. 3 in another position during the second portion of travel of the example damper member.

FIG. 7 illustrates the example damper member of FIG. 3 showing a rebound flow path during a rebound stroke.

FIGS. 8-10 illustrate the example damper of FIG. 2 having an example adjustable sleeve.

FIG. 11 is a perspective view of an example shock absorber that can be implemented on the example bicycle of FIG. 1. The example shock absorber includes an example spring and an example damper.

FIG. 12 is a side view of the example shock absorber of FIG. 11.

FIG. 13 is a side view of the example damper of the example shock absorber of FIG. 11.

FIG. 14 is a cross-sectional view of the example damper taken along line A-A of FIG. 13.

FIG. 15 is an enlarged view of an example damper body and an example damper member of the example damper of FIG. 14.

FIG. 16 is an enlarged view of the callout in FIG. 15 showing the example damper member.

FIG. 17 is an exploded view of an example piston, example seals, and example rings of the example damper member of FIG. 15.

FIG. 18 is a side view of the example piston, the example seals, and the example rings of FIG. 17 in an assembled state.

FIG. 19 is a cross-sectional view taken along line B-B of FIG. 18.

FIG. 20 is a top view of the example piston of FIG. 17.

FIG. 21 is a bottom view of the example piston of FIG. 17.

FIG. 22 illustrates the example damper member of FIG. 16 showing a first compression flow path during a first portion of travel of the example damper member during a compression stroke.

FIG. 23 illustrates the example damper member of FIG. 16 showing a second compression flow path during a second portion of travel of the example damper member during a compression stroke.

FIG. 24 illustrates the example damper member of FIG. 16 in a bottom-out position.

FIG. 25 illustrates the example damper member of FIG. 16 showing a rebound flow path during a rebound stroke.

FIG. 26 is cross-sectional view of the example damper member of FIG. 14 with an example piston having an alternative radial opening configuration and example radial flow shims.

FIG. 27 is an exploded view of the example piston and the example radial flow shims of FIG. 26.

FIG. 28 is a side view of the example piston of FIGS. 26 and 27 with the example radial flow shims.

FIG. 29 is a cross-sectional view of the example piston of FIG. 28 taken along line C-C.

FIG. 30 is a cross-sectional view of the example piston of FIG. 28 taken along line D-D.

FIG. 31 is a cross-sectional view of another example shock absorber that can be implemented on the example bicycle of FIG. 1.

The figures are not to scale. Instead, the thickness of the layers or regions may be enlarged in the drawings. In general, the same reference numbers will be used throughout the drawing(s) and accompanying written description to refer to the same or like parts.

Descriptors “first,” “second,” “third,” etc. are used herein when identifying multiple elements or components that may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Disclosed herein are example dampers that may be implemented in a suspension component of a vehicle, such as a bicycle. The example dampers may be utilized as part of a shock absorber, which incorporates a damper and a spring that act in conjunction to absorb shock impulses. The example dampers disclosed herein are position sensitive and can achieve varying levels of damping during compression based on the damper position. For example, the damper may provide a first level of damping during a first portion of the compression stroke and a second level of damping during a second portion of the compression stroke. Therefore, the damper provides two stages of compression damping. The first level of damping may be less than the second level of damping, such that there is less resistance during the initial movement to allow the shock absorber to begin to compress. This produces better tire traction when the tire makes initial contact with the ground and improves overall suspension performance.

It is generally known that a damper requires a certain breakaway force before the ends of the damper move toward or away from each other. This is because a damper typically includes a piston with one or more seals or valves, and a certain amount of pressure differential is required to open the seals or valves to enable the damper member to move. This is sometimes referred to as a cracking pressure. As such, when experiencing a compressive force, there is a slight delay while the pressure builds up before the ends of the shock absorber compress. This results in a stick slip feel that can be felt by the rider at the handlebars. Further, high frequency (e.g., frequencies above 5 hertz (Hz)), lower amplitude vibrations, such as those caused by a washboard terrain, are typically not absorbed by the damper and spring. Instead, these high frequency vibrations are transmitted through the frame and, thus, can be felt by the rider.

An example damper disclosed herein includes a damper body defining a chamber, a shaft extending into the damper body, and a damper member disposed in the chamber of the damper body and coupled to the shaft. The damper member includes a piston that is moveable (e.g., slidable) along an inner surface of the damper body. The damper member divides the chamber into a first chamber and a second camber. The damper member incudes flow paths across the piston that enable fluid to flow between the first chamber and the second chamber during compression and rebound. In particular, in some examples disclosed herein, the damper member includes a primary compression flow path with a first check valve and a bypass compression flow path with a second check valve. The second check valve has a lower cracking pressure than the first check valve. Therefore, during the initial buildup of pressure during a compression stroke, the second check valve opens to allow fluid flow from the first chamber to the second chamber through the bypass compression flow path. While the bypass compression flow path provides lower compression damping, this enables the damper to compress more quickly without such a delay as seen in known dampers. This helps to absorb shocks and vibrations more quickly, and is also advantageous when the bicycle tire makes contact with the ground (e.g., when landing). During a first portion of travel of the damper member, fluid may flow through the bypass compression flow path and the second check valve. Then, during a second portion of travel of the damper member, the second check valve closes and the pressure buildup opens the first check valve, which allows fluid flow from the first chamber to the second chamber through the primary compression flow path. In some examples, the first portion of travel may account for 15% of the shock absorber stroke, while the second portion of the travel may account for the other 85% of the shock absorber stroke. However, in other examples, the percentages can be different.

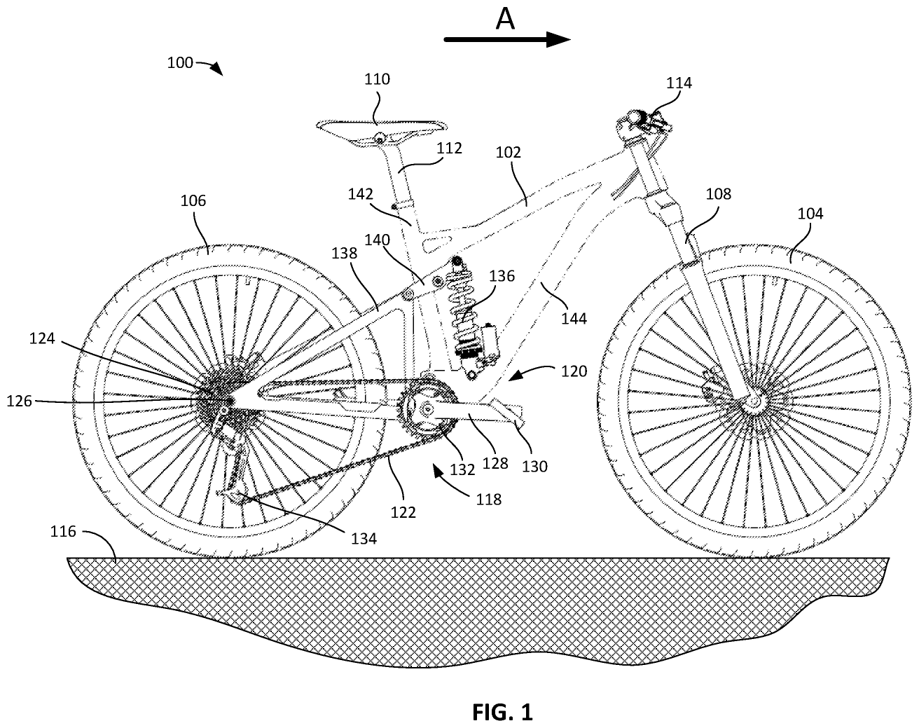

Turning now to the figures, FIG. 1 illustrates one example of a human powered vehicle on which the example suspension components disclosed herein may be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A.

In the illustrated example of FIG. 1, the bicycle 100 includes a seat 110 coupled to the frame 102 (e.g., near the rear end of the frame 102 relative to the forward direction A) via a seat post 112. The bicycle 100 also includes handlebars 114 coupled to the frame 102 and the front fork 108 (e.g., near a forward end of the frame 102 relative to the forward direction A) for steering the bicycle 100. The bicycle 100 is shown on a riding surface 116. The riding surface 116 may be any riding surface such as the ground (e.g., a dirt path, a sidewalk, a street, etc.), a man-made structure above the ground (e.g., a wooden ramp), and/or any other surface.

In the illustrated example, the bicycle 100 has a drivetrain 118 that includes a crank assembly 120. The crank assembly 120 is operatively coupled via a chain 122 to a sprocket assembly 124 mounted to a hub 126 of the rear wheel 106. The crank assembly 120 includes at least one, and typically two, crank arms 128 and pedals 130, along with at least one front sprocket, or chainring 132. A rear gear change device 134, such as a derailleur, is disposed at the rear wheel 106 to move the chain 122 through different sprockets of the sprocket assembly 124. Additionally or alternatively, the bicycle 100 may include a front gear change device to move the chain 122 through gears on the chainring 132.

The example bicycle 100 includes a suspension system having one or more suspension components. In the illustrated example, the bicycle 100 includes a rear suspension component 136. In this example, the suspension component 136 is implemented as or includes a shock absorber, referred to herein as the shock absorber 136. The shock absorber 136 is coupled between two shock attachment portions (also referred to as mounting points) on the frame 102 of the bicycle 100. For instance, in this example, the frame 102 of the bicycle 100 includes a rear triangle 138 (which can actually be two triangles, one on each side of the rear wheel 106) and a rocker 140. A lower end of the rear triangle 138 is pivotally coupled by a link to the frame 102 at or near an intersection of a seat tube 142 and a down tube 144 of the frame 102. In the illustrated example, the rocker 140 is pivotally coupled to the seat tube 142 of the frame 102. An upper end of the rear triangle(s) 138 is/are pivotally coupled to one end of the rocker 140. The other end of the rocker 140 is coupled to one end of the shock absorber 136 (e.g., via a bolt or pin). The other end of the shock absorber 136 is coupled to the down tube 144 (e.g., via a bolt or pin). If the rear wheel 106 is moved upward (such as when riding over a bump), the rocker 140 is rotated in the clockwise direction (in FIG. 1), which compresses the shock absorber 136. When the force is removed, the shock absorber 136 expands (rebounds), thereby moving the rear wheel 106 back downward to maintain traction with the surface 116. Thus, the shock absorber 136 is coupled between two sections of the frame 102 that are moveable relative to each other.

In some examples, the front fork 108 is also implemented as a front suspension component. For example, a spring can be integrated into one of the legs and a damper can be integrated into the other leg. Therefore, the front fork 108 and the shock absorber 136 absorb shocks and vibrations while riding the bicycle 100 (e.g., when riding over rough terrain). In other examples, the front fork 108 and/or the shock absorber 136 may be integrated into the bicycle 100 in other configurations or arrangements. Further, in other examples, the suspension system may employ only one suspension component (e.g., only the shock absorber 136) or more than two suspension components (e.g., an additional suspension component on the seat post 112) in addition to or as an alternative to the front fork 108 and the shock absorber 136.

While the example bicycle 100 depicted in FIG. 1 is a type of mountain bicycle, the example suspension components disclosed herein can be implemented on other types of bicycles. For example, the example suspension components disclosed herein may be used on road bicycles, as well as bicycles with mechanical (e.g., cable, hydraulic, pneumatic, etc.) and non-mechanical (e.g., wired, wireless) drive systems. The example suspension components disclosed herein may also be implemented on other types of two-wheeled, three-wheeled, and four-wheeled human powered vehicles. Further, the example suspension components disclosed herein can be used on other types of vehicles, such as motorized vehicles (e.g., a motorcycle, a car, a truck, etc.).

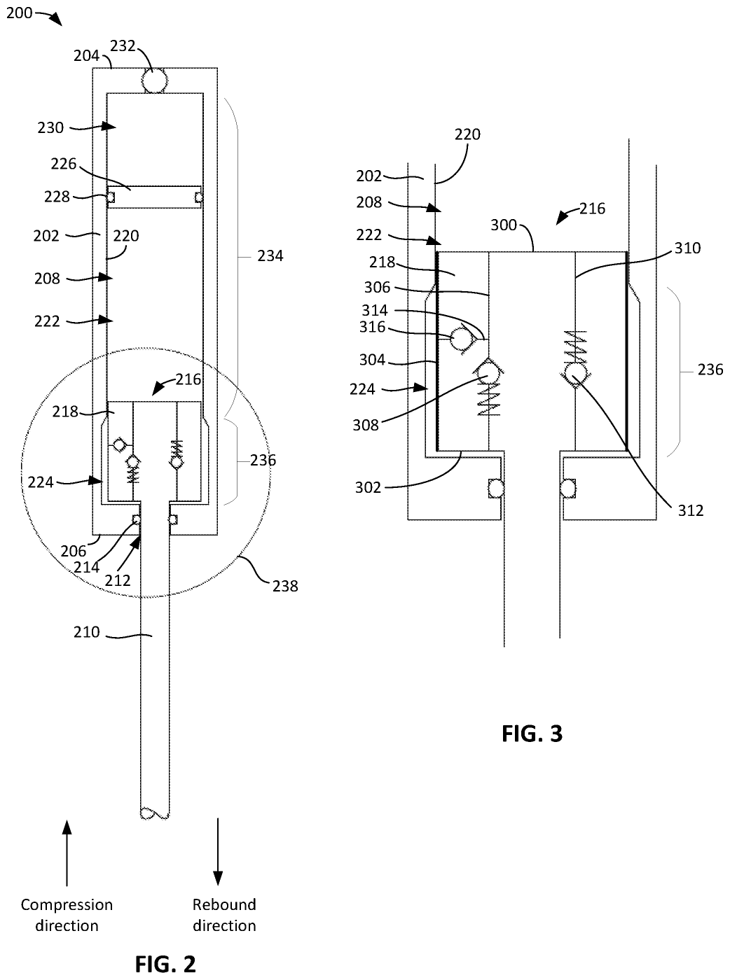

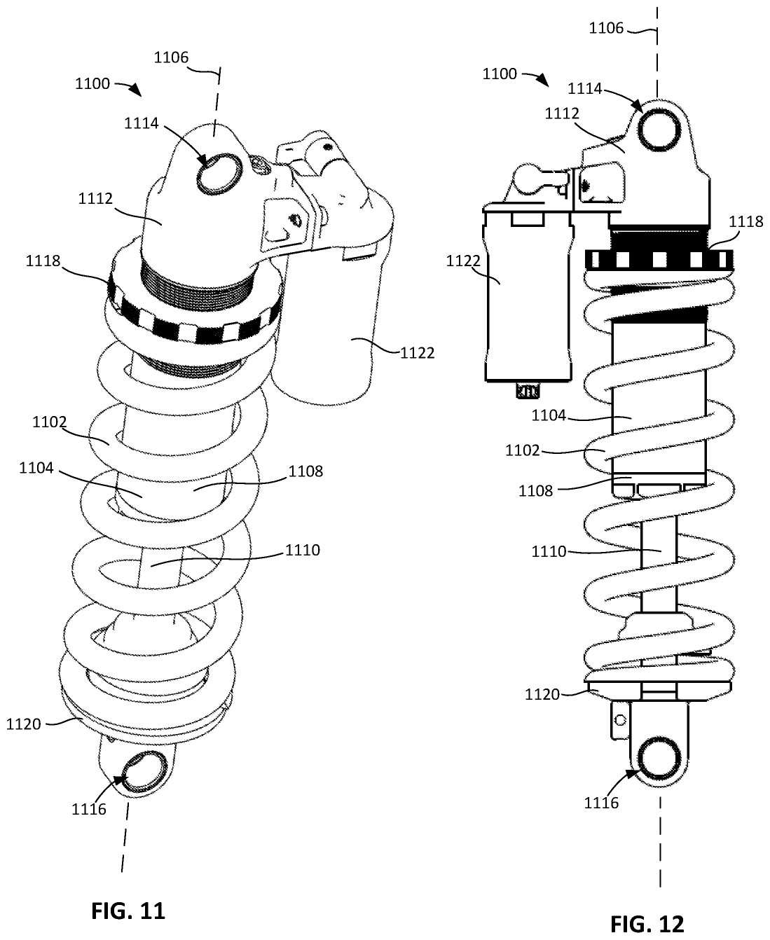

FIG. 2 is a schematic diagram of an example damper 200 that can be implemented on the bicycle 100 of FIG. 1. For example, the damper 200 can be integrated into the example shock absorber 136. An example of a physical implementation of the damper 200 is disclosed in further detail in connection with FIGS. 11-25. In the illustrated example of FIG. 2, the damper 200 includes a damper body 202 having a first end 204 and a second end 206 opposite the first end 204. The damper body 202 may be a cylindrical body having a circular cross-sectional shape. In other examples, the damper body 202 may have a differently shaped cross-section (e.g., square). The damper body 202 defines a chamber 208. In the illustrated example, the damper 200 includes a shaft 210 (also referred to as a damper rod or stem) that extends into the damper body 202. In particular, the second end 206 of the damper body 202 has an opening 212 with a seal 214. The shaft 210 extends through the opening 212 and the seal 214 and into the chamber 208. The shaft 210 is moveable (e.g., slidable) through the opening 212 into and out of the damper body 202 as the damper 200 compresses and rebounds.

In the illustrated example, the damper 200 includes a damper member 216 disposed the damper body 202. The damper member 216 may also be referred to as a flow control member. The damper member 216 is disposed in the chamber 208 and coupled to the shaft 210. The damper member 216 includes a piston 218. The damper member 216 is moveable in the damper body 202. In particular, the damper member 216 is slidable along an inner surface 220 of the damper body 202. The damper member 216 is sealingly engaged with the inner surface 220. As such, the damper member 216 divides the chamber 208 into a first chamber 222 (e.g., the section of the chamber 208 above the damper member 216) and a second chamber 224 (e.g., the section of the chamber 208 below the damper member 216). The volumes of the chambers 222, 224 change as the damper member 216 moves up and down in the damper body 202. The first and second chambers 222, 224 are filled with fluid. The fluid may be, for example, oil, such as a mineral oil based damping fluid. In other examples, other types of damping fluids may be used (e.g., silicone or glycol type fluids). The damper member 216 controls fluid flow between the first chamber 222 and the second chamber 224. In particular, the damper member 216 controls the flow of fluid across the piston 218 and between the first and second chambers 222, 224 to dampen movement of the shock absorber.

In the illustrated example of FIG. 2, the damper 200 includes an internal floating piston (IFP) 226 that is slidably disposed within the damper body 202. A seal 228 is disposed between the IFP 226 and the inner surface 220 of the damper body 202. As shown in FIG. 2, the IFP 226 separates the fluid in the first chamber 222 from a pneumatic pressure chamber 230 having a pneumatic fluid. The pneumatic fluid may be a compressible fluid, such as air or nitrogen, while the fluid in the first chamber 222 may be an incompressible fluid, such as oil. The IFP 226 is moveable upward or downward based on the pressure differential across the IFP 226. The IFP 226 provides pressure on the fluid (e.g., oil) in the first chamber 222 to force the fluid through the flow paths in the piston 218 and prevent cavitation on the piston 218. The IFP 226 also compensates for the volume that the shaft 210 consumes when inserted into the damper body 202 (e.g., during assembly). The damper 200 includes a valve 232 to add or remove pneumatic fluid from the pneumatic pressure chamber 230. In other examples, instead of an IFP, the damper 200 may include a flexible bladder to separate the compressible and incompressible fluids. As another example, the damper 200 may include an open damping chamber with no physical separation, where the compressible fluid is on top and the incompressible fluid is on the bottom and gravity maintains the separation.

In the illustrated example, the chamber 208 has a first section 234 with a first cross-sectional area and a second section 236 with a second cross-sectional area that is greater than the first cross-sectional area. Because the damper body 202 has a circular cross-section, the first and second cross-sectional areas can also be defined by diameters. For example, the first section 234 has a first diameter and the second section 236 has a second diameter that is greater than the first section 234. In the illustrated example, the second section 236 having the larger cross-sectional area/diameter occurs closer to the second end 206. In this example, the second section 236 is shorter than the first section 234, but in other examples the lengths of the first and second sections 234, 236 may be different.

In operation, the first end 204 of the damper 200 may be coupled (directly or indirectly) to one frame member, and the shaft 210 may be coupled (directly or indirectly) to another frame member. As used herein, a compression stroke refers to the movement that occurs when the damper member 216 is moved (slid) toward the first end 204 of the damper body 202 and away from the second end 206 of the damper body 202. A compression stroke can be caused by any external force that moves the damper body 202 and the shaft 210 toward each other. This may occur, for example, when a rider rides over an object that causes the rear wheel 106 (FIG. 1) to be rotated upward toward the frame 102 (FIG. 1), when a rider comes down off of a jump and lands on the ground, etc. During a compression stroke, the shaft 210 is moved into the damper body 202, which moves the damper member 216 toward the first end 204 of the damper body 202. This movement causes an increased pressure of the fluid in the first chamber 222 and a decreased pressure of the fluid in the second chamber 224. During the compression stroke, fluid flows through one or more compression flow paths and across the piston 218 from the first chamber 222 to the second chamber 224, as disclosed in further detail herein. Conversely, as used herein, a rebound stroke refers to the movement that occurs when the damper member 216 is moved (slid) in the opposite direction, i.e., away from the first end 204 of the damper body 202 and toward the second end 206 of the damper body 202. The rebound movement may be driven by a spring (e.g., a coil spring, an air can) of the shock absorber and/or by the frame members moving apart. During a rebound stroke, the shaft 210 is moved out of the damper body 202, which moves the damper member 216 toward the second end 206 of the damper body 202. This movement causes an increased pressure of the fluid in the second chamber 224 and a decreased pressure of the fluid in the first chamber 222. During the rebound stroke, fluid flows through one or more rebound flow paths and across the piston 218 from the second chamber 224 to the first chamber 222. The damper member 216 is configured to control the flow of fluid through or across the piston 218 between the first and second chambers 222, 224, thereby damping movement of the shock absorber. As disclosed in further detail herein, the damper member 216 includes a unique arrangement of compression flow paths that provide varying levels of compression damping based on the position of the damper member 216.

The damper member 216 is moveable between a top-out position and a bottom-out position, which form the upper and lower limits of the movement of the damper member 216. In FIG. 2, the damper member 216 is shown in the top-out position, which means the damper 200 is fully extended or uncompressed. In some examples, in the top-out position, the damper member 216 is engaged with a structure such as the second end 206, which prevents further movement of the damper member 216 in one direction. During compression, the damper member 216 can be moved upward to the bottom-out position, which refers to the limit at which the damper 200 is fully compressed. The bottom-out position may correspond to a position where pressure in the chamber 208 prevents the damper member 216 from moving upward and/or where the damper member 216 engages a structure, such as the IFP 226.

FIG. 3 is an enlarged view of the callout 238 in FIG. 2. The piston 218 of the damper member 216 has a first end 300, a second end 302 opposite the first end 300, and an outer side surface 304 between the first and second ends 300, 302. At least a portion of the outer side surface 304 of the piston 218 is sealingly engaged (directly or via one or more seals) with the inner surface 220 of the damper body 202 along the first section 234 (FIG. 2) to limit fluid flow between the piston 218 and the inner surface 220 of the damper body 202. This sealing engagement separates the chamber 208 into the first chamber 222 and the second chamber 224.

In the illustrated example, the piston 218 has a first port, referred to herein as a primary compression port 306, that extends between the first and second ends 300, 302 of the piston 218. The damper member 216 includes a first valve 308, referred to herein as a primary compression valve 308, in the primary compression port 306 to control fluid flow through the primary compression port 306. The piston 218 also has or defines a second port 310, referred to herein as a rebound port 310, between the first and second ends 300, 302 with a second valve 312, referred to herein as a rebound valve 312, in the rebound port 310 to control fluid flow through the rebound port 310. The primary compression port 306 and the rebound port 310 may be formed by any number of passages, conduits, channels, etc. The primary compression valve 308 and the rebound valve 312 are check valves (sometimes referred to as one-way valves), which allow fluid flow in one direction but not the opposite direction. In particular, the primary compression valve 308 allows fluid flow through the primary compression port 306 from the first chamber 222 to the second chamber 224, but not from the second chamber 224 to the first chamber 222. Conversely, the rebound valve 312 allows fluid flow through the rebound port 310 from the second chamber 224 to the first chamber 222, but not from the first chamber 222 to the second chamber 224.

In the illustrated example, the piston 218 also has or defines a third port 314, referred to herein as a bypass compression port 314, which defines a flow path between the first end 300 and the outer side surface 304. In the illustrated example, the bypass compression port 314 extends between a portion of the primary compression port 306 and the outer side surface 304 of the piston 218. However, in other examples, the bypass compression port 314 can be a separate port that extends between the first end 300 and the outer side surface 304. The bypass compression port 314 may be formed by any number of passages, conduits, channels, etc. The bypass compression port 314 exits out of the outer side surface 304 rather than the second end 302. In the position shown in FIG. 3, the exit of the bypass compression port 314 is aligned with the second section 236 of the chamber 208. The damper member 216 includes a third valve 316, referred to herein as a bypass compression valve 316, in the bypass compression port 314 to control fluid flow through the bypass compression port 314. The bypass compression valve 316 is a check valve, which allows fluid flow through the bypass compression port 314 from the first end 300 to the outer side surface 304, but not from the outer side surface 304 to the first end 300. In this example, the bypass compression valve 316 has a lower cracking pressure than the primary compression valve 308. As such, the bypass compression valve 316 allows fluid from the first chamber 222 to the second chamber 224 during the initial part of the compression stroke, which allows the damper 200 to compress more quickly during the initial part of the compression stroke.

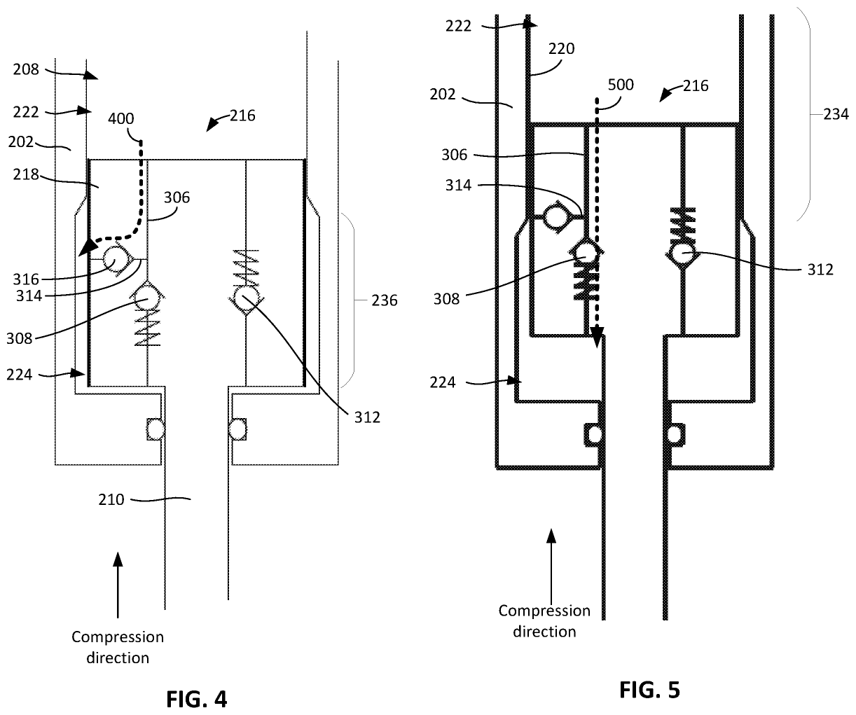

For example, FIG. 4 illustrates a first compression flow path 400 (shown as a dotted line) along which fluid flows during a first portion of the travel of the damper member 216 during a compression stroke. The first compression flow path 400 defines a flow path across the piston 218 from the first chamber 222 to the second chamber 224. In FIG. 4, the piston 218 is shown in the top-out position. In this position, the outlet of the bypass compression port 314 is aligned with or open to the second section 236 of the chamber 208 in the damper body 202. When a compressive force is applied to the shaft 210, the piston 218 is forced upward in the damper body 202. This increases the pressure in the first chamber 222 to be greater than the second chamber 224. The pressure differential between the first and second chambers 222, 224 overcomes the cracking pressure of the bypass compression valve 316 and opens the bypass compression valve 316. As such, fluid from the first chamber 222 flows through a portion of the primary compression port 306, through the bypass compression port 314 and the bypass compression valve 316, and to the second chamber 222 along the first compression flow path 400. Because the bypass compression valve 316 has a lower cracking pressure than the primary compression valve 308, this allows the damper 200 to compress more quickly when a shock or impulse is encountered. During this initial movement of the damper member 216, the pressure differential may not be enough to overcome the cracking pressure of the primary compression valve 308, so the primary compression valve 308 remains closed during the first portion of travel of the damper member 216. Further, during a compression stroke, the rebound valve 312 remains closed.

FIG. 5 illustrates a second compression flow path 500 (shown as a dotted line) along which fluid flows during a second portion of the travel of the damper member 216 during the compression stroke. As shown in FIG. 5, the damper member 216 has moved upward in the chamber 208 relative to the position shown in FIG. 4. The bypass compression port 314 is aligned with the first section 234 and blocked by the inner surface 220 of the damper body 202. Therefore, the first compression flow path 400 (FIG. 4) is blocked or obstructed, and the bypass compression valve 316 remains closed during the second portion of travel of the damper member 216. Instead, the pressure differential between the first and second chambers 222, 224 overcomes the cracking pressure of the primary compression valve 308 and opens the primary compression valve 308. As such, fluid from the first chamber 222 flows through the primary compression port 306 and the primary compression valve 308 to the second chamber 224 along the second compression flow path 500. Fluid continues to flow along the second compression flow path 500 as the damper member 216 is moved further upward in the damper body 202. For example, as shown in FIG. 6, the damper member 216 has been moved further upward in the damper body 202 during the compression stroke. The fluid continues to flow along the second compression flow path 500. During this second portion of travel of the compression stroke, the rebound valve 312 remains closed.

Therefore, during the first portion of travel of the damper member 216 during a compression stroke, the bypass compression valve 316 opens to enable fluid flow through the bypass compression port 314 from the first chamber 222 to the second chamber 224, and during the second portion of travel of the damper member 216 during the compression stroke, the primary compression valve 308 opens to enable fluid flow through the primary compression port 306 from the first chamber 222 to the second chamber 224. The first portion of travel corresponds to movement of the damper member 216 from the top-out position shown in FIG. 4 to the position shown in FIG. 5, and the second portion of travel corresponds to movement of the damper member 216 from the position shown in FIG. 5 to the bottom-out position (or any position the damper member 216 stops before rebound). During the first portion of travel of the damper member 216, fluid flows along the first compression flow path 400, and during the second portion of the damper member 216 during the compression stroke, fluid flows along the second compression flow path 500. The first compression flow path 400 has a larger cross-sectional flow area that results in little damping, whereas the second compression flow path 500 has a smaller cross-sectional flow are that results in greater damping. Therefore, during the first portion of travel, the damper 200 provides less resistance or damping, whereas during the second portion of travel, the damper 200 provides more resistance or damping. The transition between the first and second portion of travel occurs where the cross-sectional area of the chamber 208 changes. In other examples, this transition can be achieved by a dimple or slot along the inner surface 220 and/or a port (e.g., a channel) formed in the damper body 202. The distance or length of the first and second travel portions can be configured based the length of the first and second sections 234, 236, the size of the piston 218, and/or the location of the bypass compression port 314.

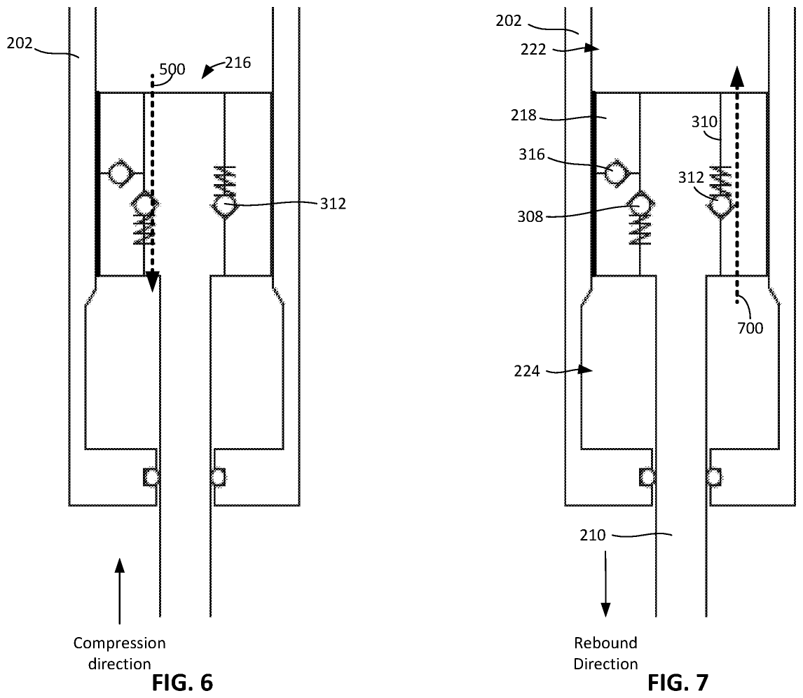

FIG. 7 illustrates a rebound flow path 700 (shown as a dotted line) along which fluid flows during a rebound stroke. When a rebound force is applied to the shaft 210, the piston 218 is forced downward in the damper body 202. The pressure differential between the first and second chambers 222, 224 opens the rebound valve 312. As such, fluid from the second chamber 224 flows through the rebound port 310 and the rebound valve 312 to the first chamber 222 along the rebound flow path 700. During rebound, the primary compression valve 308 and the bypass compression valve 316 remain closed.

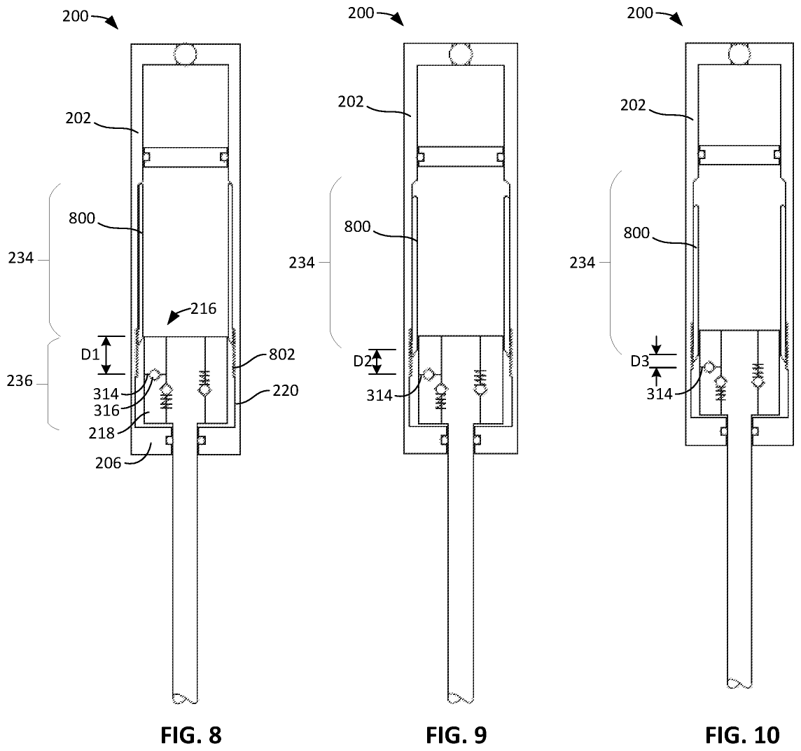

In some examples, the damper 200 is adjustable to change the distance or stroke length that corresponds to the first portion of the travel of the compression stroke. For example, in FIG. 8, the damper 200 includes an example sleeve 800 in the damper body 202. The sleeve 800 is threadably engaged with a threaded section 802 on the inner surface 220 of the damper body 202. The piston 218 is sealingly engaged (e.g., directly or indirectly) with the sleeve 800. The sleeve 800 forms the inner surface of the damper body 202 along the first section 234 with the first cross-sectional area, and the section of the damper body 202 between the sleeve 800 and the second end 206 of the damper body 202 forms the second section 236 with the second cross-sectional area. The distance D1 between the bypass compression port 314 and the first section 234 (i.e., the start of the sleeve 800) corresponds to the first travel portion in which the bypass compression valve 316 is open to enable fluid flow along the first compression flow path 400 (FIG. 4).

The sleeve 800 is moveable to adjust a length of the first section 234 and a length of the second section 236, thereby changing the distance or length of the first and second travel portions. For example, as shown in FIG. 9, the sleeve 800 has been moved downward in the damper body 202. This may occur by rotating (e.g., screwing) the sleeve 800 relative to the damper body 202. As shown in FIG. 9, the distance D2 between the bypass compression port 314 and the first section 234 is less than the distance D1 in FIG. 8. As such, in the configuration in FIG. 9, the first portion of the travel is less than the first portion of the travel in the configuration of FIG. 8. In FIG. 10, the sleeve 800 has been moved further downward in the damper body 202. The distance D3 between the bypass compression port 314 and the first section 234 is less than the distance D1 in FIG. 8 and less than the distance D2 in FIG. 9. As such, in this configuration, the first travel portion is relatively short. A user (e.g., a rider) can adjust the sleeve based on their desired damping preference. Adjusting the position of the sleeve 800 does not affect the overall length of the damper 200. As such, the damper 200 can continue to be used in the same spaces. However, in other examples, the overall length of the damper 200 may be changed. In some examples, adjusting the sleeve 800 involves disassembling at least a portion of the damper 200. In other examples, one or more mechanisms can be provided to enable a user to adjust the position of the sleeve 800 without disassembly. For example, a worm gear can be disposed on the sleeve 800 and accessed from outside of the damper body 202, one or more tool access ports can be provided on the damper body 202, and/or one or more electric motors or actuators can be provided.

In examples of FIGS. 2-10, the bypass compression port 314 and the bypass compression valve 316 form a first means for allowing fluid flow across the piston 218 from the first chamber 222 to the second chamber 224 during a first portion of travel of the damper member 216 during a compression stroke. The primary compression port 306 and the primary compression valve 308 form a second means for allowing fluid flow across the piston 218 from the first chamber 222 to the second chamber 224 during a second portion of travel during a compression stroke. The first means (i.e., the bypass compression port 314 and the bypass compression valve 316) provide less fluid resistance than the second means (i.e., primary compression port 306 and the primary compression valve 308). In other examples, the first means may be provided by another configuration of channels, ports, valves, etc. In some examples, the damper 200 includes means for controlling a length of the first portion of the travel, such as the sleeve 800.

FIGS. 11 and 12 illustrate an example shock absorber 1100 (a suspension component) constructed in accordance with the teachings of this disclosure. The example shock absorber 1100 can be implemented as the shock absorber 136 and used on the bicycle 100 of FIG. 1. For example, the shock absorber 1100 can be coupled between the frame 102 and the rocker 140 to absorb vibrations and shocks from the rear wheel 106. In the illustrated example of FIGS. 11 and 12, the shock absorber 1100 includes an integrated spring 1102 and damper 1104. The spring 1102 operates (by compressing or expanding) to absorb vibrations or shocks, while the damper 1104 operates to dampen (slow) the movement of the spring 1102. The example damper 1104 can correspond to and/or implement the example features disclosed in connection with the example damper 200 of FIGS. 2-10.

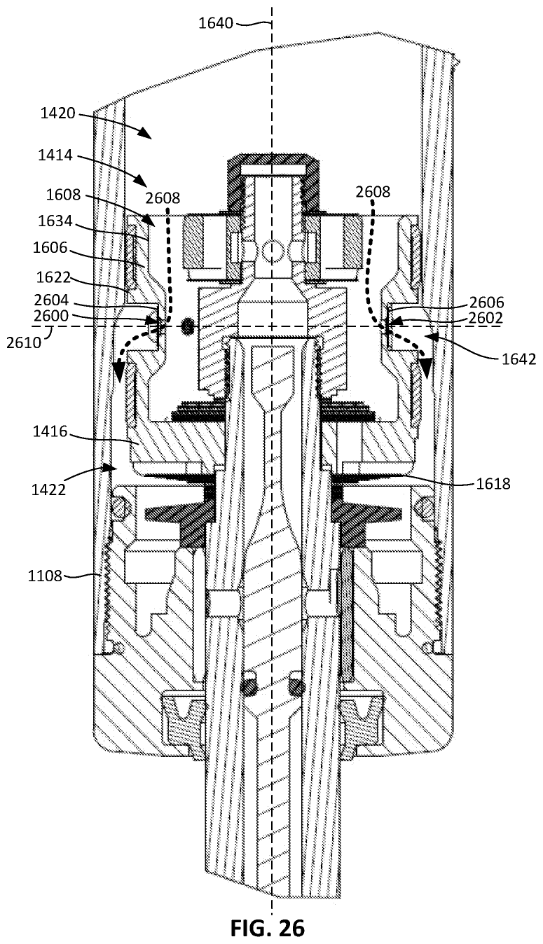

In the illustrated example, the spring 1102 is implemented as a coil spring. However, in other examples, the spring 1102 may be implemented as another type of spring, such as an air can as shown in connection with FIG. 26. The spring 1102 and the damper 1104 are configured in a coaxial arrangement and aligned along an axis 1106, which corresponds to a central or longitudinal axis of the shock absorber 1100.

In the illustrated example, the damper 1104 includes a damper body 1108 and a shaft 1110 (also referred to as a damper rod or stem) that is moveable into and out of the damper body 1108. The shock absorber 1100 includes a cap 1112 that is coupled (e.g., threadably coupled) to the damper body 1108 and forms a first end (e.g., a top) of the damper body 1108. The cap 1112 includes a first attachment portion 1114. The distal end of the shaft 1110 includes a second attachment portion 1116. The first and second attachment portions 1114, 1116 (e.g., eyelets) are used for connecting the shock absorber 1100 between two components of a bicycle, such as two points on the frame 102 (FIG. 1) of the bicycle 100 (FIG. 1), the frame 102 and the rocker 140 (FIG. 1), and/or another intermediate part or component. In the illustrated example, the first and second attachment portions 1114, 1116 are aligned along the axis 1106.

In the illustrated example, the shock absorber 1100 includes a first spring retainer 1118 coupled to the damper body 1108 and a second spring retainer 1120 coupled to the shaft 1110. The spring 1102 is disposed between the first and second spring retainers 1118, 1120. During compression, the first and second attachment portions 1114, 1116 are pushed toward each other, which moves the shaft 1110 into the damper body 1108 and compresses the spring 1102 between the first and second spring retainers 1118, 1120. Conversely, during rebound, the first and second attachment portions 1114, 1116 are pushed (or and/or pulled) apart at least in part by force from the spring 1102, which moves the shaft 1110 out of the damper body 1108.

In the illustrated example of FIGS. 11 and 12, the damper 1104 includes an external reservoir 1122 (sometimes referred to as a shock can or shock piggy-back can). The external reservoir 1122 is disposed outside of the damper body 1108. The external reservoir 1122 is used to house excess damper fluid as the shock absorber 1100 compresses and/or rebounds. In particular, during compression and rebound, damper fluid is routed between the damper body 1108 and the external reservoir 1122. This type of shock absorber having an external reservoir has many advantages, such as for keeping nitrogen (or other pneumatic fluid) away from the main body of the shock absorber 1100, splitting the load of a shock between two compression circuits, and enabling the use of larger internal floating pistons. However, in other examples, the shock absorber 1100 may not include an external reservoir. Instead, the reservoir may be defined in the damper body 1108 or another area in the tubed structured.

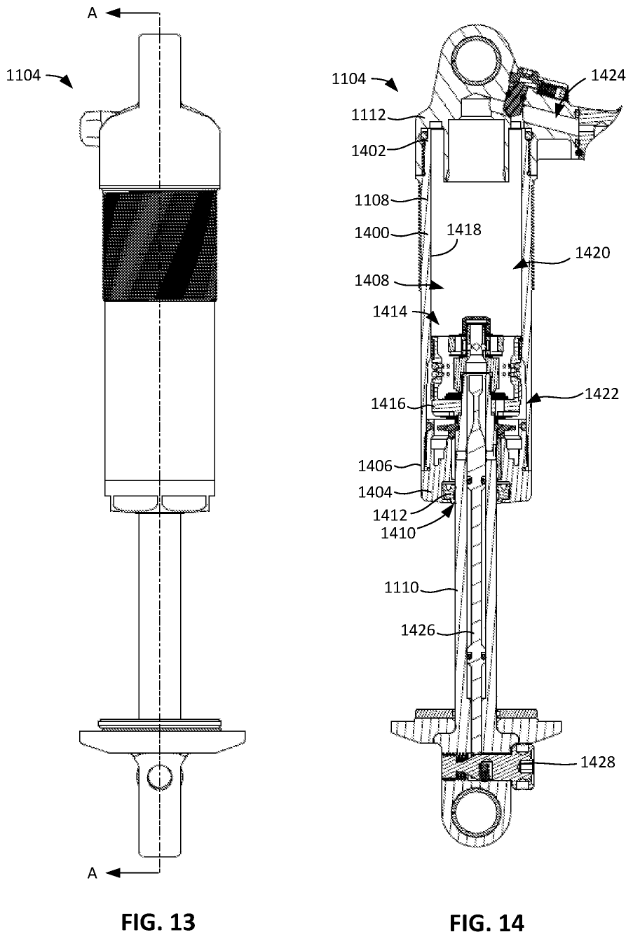

FIG. 13 is a side view of the example damper 1104. In FIG. 13, the example spring 1102 and the example first spring retainer 1118 have been removed. FIG. 14 is a cross-sectional view of the example damper 1104 taken along line A-A of FIG. 13. As shown in FIG. 13, the damper body 1108 includes a sleeve or tube 1400. The cap 1112 is coupled to a first end 1402 of the sleeve 1400 and forms a first end (e.g., a top end) of the damper body 1108. Further, the damper body 1108 include an end cap 1404 that is coupled to a second end 1406 of the tube 1400 and forms a second end (e.g., a bottom end) of the damper body 1108.

In the illustrated example of FIG. 14, the damper body 1108 defines a chamber 1408. The chamber 1408 is filled with fluid. The fluid may be, for example, oil, such as a mineral oil based damping fluid. In other examples, other types of damping fluids may be used, such as silicone or glycol type fluids. In the illustrated example, the end cap 1404 has an opening 1410 with a seal 1412. The shaft 1110 extends through the opening 1410 and the seal 1412 and into the chamber 1408.

In the illustrated example of FIG. 14, the damper 1104 includes a damper member 1414 (which may also be referred to as a flow control member) disposed in the chamber 1408 and coupled to the shaft 1110. The damper member 1414 includes a piston 1416. The piston 1416 is movable in the damper body 1108. In particular, the piston 1416 is slidable along an inner surface 1418 of the tube 1400 of the damper body 1108. The damper member 1414 divides the chamber 1408 into a first chamber 1420 (which is on the top side of the damper member 1414 in FIG. 14) and a second chamber 1422 (which is on the bottom side of the damper member 1414 in FIG. 14). The damper member 1414 controls the flow of fluid across the piston 1416 between the first and second chambers 1420, 1422 in the damper body 1108, which affects the speed at which the shock absorber 1100 compresses and/or rebounds. The damper 1414 has a unique valve design that enables different damping rates during a compression stroke, as disclosed in further detail herein.

During a compression stroke, the shaft 1110 is moved into the damper body 1108, which moves the piston 1416 upward toward the cap 1112. This movement causes an increased pressure of the fluid in the first chamber 1420 and a decreased pressure of the fluid in the second chamber 1422. During the compression stroke, fluid flows through one or more compression flow paths and across the piston 1416 from the first chamber 1420 to the second chamber 1422, as disclosed in further detail herein. During a rebound stroke, the shaft 1110 is moved out of the damper body 1108, which moves the piston 1416 downward toward the end cap 1404. This movement causes an increased pressure of the fluid in the second chamber 1422 and a decreased pressure of the fluid in the first chamber 1420. During the rebound stroke, fluid flows through one or more rebound flow paths and across the piston 1416 from the second chamber 1422 to the first chamber 1420. The damper member 1414 is configured to control the flow of fluid through or across the piston 1416 between the first and second chambers 1420, 1422, thereby affecting the compression and rebound damping rates. As shown in FIG. 14, the cap 1112 has a passageway 1424 to enable fluid in the chamber 1408 to flow into and out of the external reservoir 1122 (FIGS. 11 and 12). In some examples, the external reservoir 1122 includes an internal floating piston, which separates the fluid from a pneumatic chamber, similar to the arrangement disclosed in connection with the damper 200 in FIG. 2. In the illustrated example, the damper 1104 includes a needle 1426 to adjust the rebound damping rate. The needle 1426 is coaxially disposed in the shaft 1110. The needle 1426 can be moved axially, via a knob 1428, to adjust the rebound flow rate across the damper member 1414.

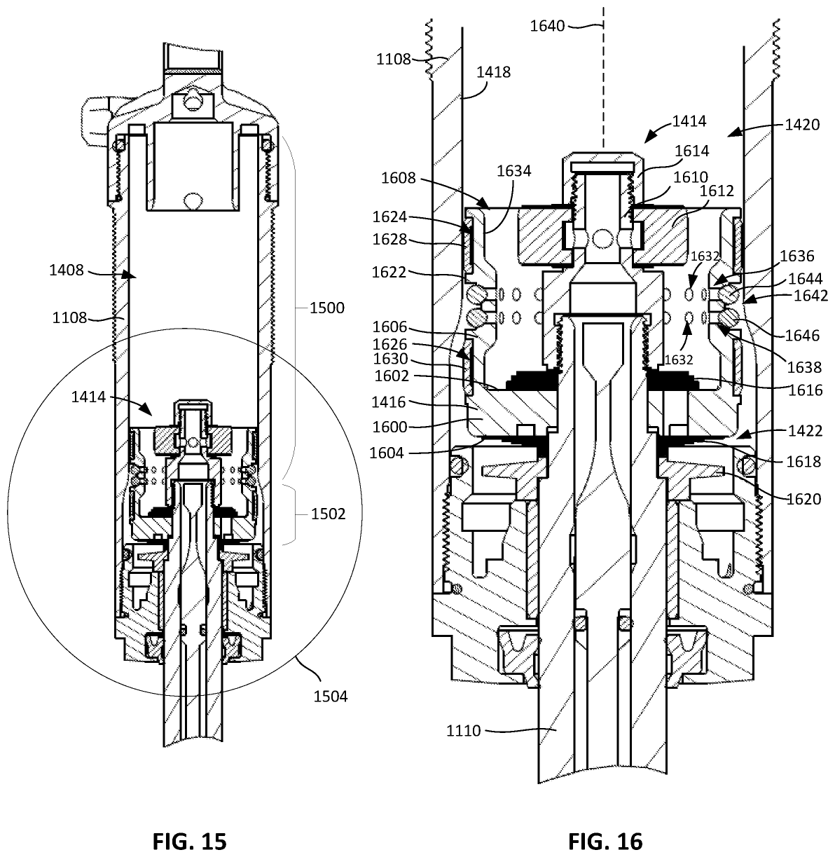

FIG. 15 is an enlarged view of the damper body 1108 and the damper member 1414 from FIG. 14. As shown in FIG. 15, the chamber 1408 of the damper body 1108 has a first section 1500 with a first cross-sectional area and a second section 1502 with a second cross-sectional area that is greater than the first cross-sectional area. The second section 1502 is near the second end 1406. Because the damper body 1108 has a circular cross-section, the first and second cross-sectional areas can also be defined by diameters. For example, the first section 1500 has a first diameter and the second section 1502 has a second diameter that is larger than the first section 1500. In this example, the second section 1502 is shorter than the first section 1500, but in other examples the lengths of the first and second sections 1500, 1502 may be different. In the illustrated example, the transition between the first cross-sectional area/diameter and the second cross-sectional area/diameter is gradual or tapered. In other examples, the transition may be more distinct (e.g., a 90° shoulder).

FIG. 16 is enlarged view of the callout 1504 of FIG. 15. In the illustrated example, the piston 1416 includes a disc 1600 having a first side 1602 and a second side 1604 opposite the first side 1602. The piston 1416 includes a wall 1606 coupled to extending from the first side 1602 of the disc 1600. In some examples, the disc 1600 and the wall 1606 are constructed as a single unitary part or component (e.g., a monolithic structure). In other examples, the disc 1600 and the wall 1606 can be constructed as two separate parts that are coupled together (e.g., via welding). The wall 1606 forms a cavity 1608. In the illustrated example, the damper member 1414 includes a piston bolt 1610 that is threadably coupled to the shaft 1110, which couples the piston 1416 to the shaft 1110. The damper member 1414 includes a check plate 1612 and a nut 1614 coupled to the piston bolt 1610. In the illustrated example, the damper member 1414 has a rebound shim stack 1616 on the first side 1602 of the disc 1600 of the piston 1416 and a compression shim stack 1618 on the second side 1604 of the disc 1600 of the piston 1416. The rebound shim stack 1616 is clamped between the piston bolt 1610 and the first side 1602 of the disc 1600. The compression shim stack 1618 is clamped between a retainer 1620 and the second side 1604 of the disc 1600.

The piston 1416 is sealingly engaged with the inner surface 1418 of the damper body 1108. In this example, an outer surface 1622 of the piston 1416 has a first seal groove 1624 (e.g., a gland) and a second seal groove 1626 axially spaced from the first seal groove 1624. The damper member 1414 includes a first seal 1628 disposed in the first seal groove 1624 and around the piston 1416. The damper member 1414 also includes a second seal 1630 disposed in the second seal groove 1626 and around the piston 1416. In some examples, the first and second seals 1628, 1630 are implemented as wearbands constructed of polytetrafluoroethylene (commonly referred to as Teflon). In other examples, the wearbands can be constructed of other polymers and/or materials. In some examples, the wearbands are continuous bands that are installed by stretching the wearbands over the piston 1416, and then are compressed (sized) into place. In other examples, the wearbands may have a split, and can be installed by spreading apart the ends of the split and/or stretching the wearbands over the piston 1416. In other examples, the seals 1628, 1630 can be constructed as other types of seals. As shown in FIG. 16, the first seal 1628 is engaged with the inner surface 1418 of the damper body 1108. As such, at least a portion of the outer surface 1622 of the piston 1416 is sealed with the inner surface 1418 of the damper body 1108. This prevents fluid flow between the outer surface 1622 of the piston 1416 and the inner surface 1418 of the damper body 1108, thereby fluidly separating the first and second chambers 1420, 1422. The first seal 1628 remains engaged with the inner surface 1418 of the damper body 1108 as the damper member 1414 moves up and down during compression and rebound. In the position shown in FIG. 16, the second seal 1630 is not engaged with the inner surface 1418. However, as disclosed in further detail herein, when the piston 1416 is moved upward, the second seal 1630 engages the inner surface 1418 for a portion of the travel during the compression stroke.

In the illustrated example, the piston 1416 has a plurality of radial openings 1632 (two of which are referenced in FIG. 16). In this example, the radial openings 1632 are distributed circumferentially around the wall 1606 of the piston 1416. The radial openings 1632 extend through the wall 1606 between the outer surface 1622 of the wall 1606 and an inner surface 1634 of the wall 1606. The radial openings 322 enable fluid flow between the second chamber 1422 and the cavity 1608. The radial openings 1632 are axially spaced between the first and second seals 1628, 1630. Any number of radial openings may be provided (e.g., one, two, three, etc.). In this example, the radial openings 1632 include are arranged in a first set 1636 (e.g., a first ring) and a second set 1638 (e.g., a second ring) that are axially spaced apart. However, in other examples, the piston 1416 may include only one set or ring of radial openings. In some examples, the radial openings 1632 are spaced equidistant from one another. In the illustrated example, the radial openings 1632 are circular shaped. In other examples, the radial openings 322 can be shaped differently (e.g., square, triangular, polygonal, etc.). In this example, the radial openings 1632 are aligned along axes that are transverse (e.g., perpendicular) to an axis of movement 1640 along which the damper member 1414 moves (e.g., up and down in FIG. 16). Therefore, the radial openings 1632 define flow paths that are transverse to the axis of movement 1640. In some examples, the radial openings 1632 are aligned along axes that are radial (perpendicular) to the axis of movement 1640 of the damper member 1414.

In the illustrated example, the outer surface 1622 of the piston 1416 has a recess 1642 (e.g., a gland) between the first and second seal groves 1624, 1626. In the illustrated example, the damper member 1414 includes a first ring 1644 and a second ring 1646 disposed around the wall 1606 of the piston 1416. In particular, the first ring 1644 is disposed in the recess 1642 and aligned with the first set 1636 of the radial openings 1632, and the second ring 1646 is disposed around the wall 1606 and aligned with the second set 1638 of the radial openings 1632. In other examples, the piston 1416 may include only one set of radial openings, in which case the damper member 1414 may include only one ring. The first and second rings 1644, 1646 are radially expandable and act as check valves, as disclosed in further detail herein. In some examples, the first and second rings 1644, 1646 are implemented as o-rings.

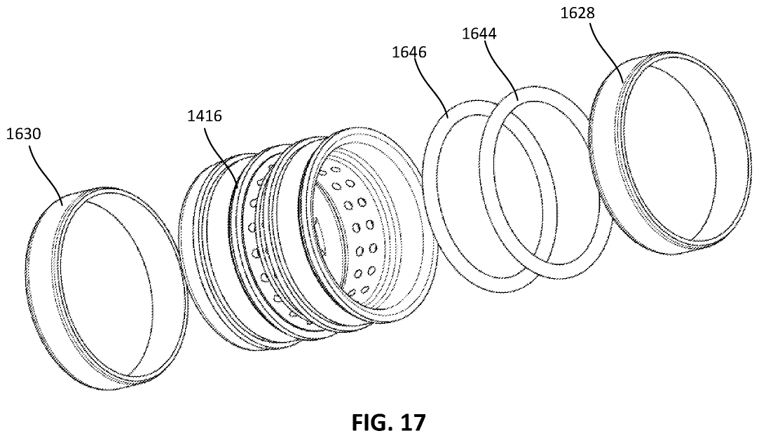

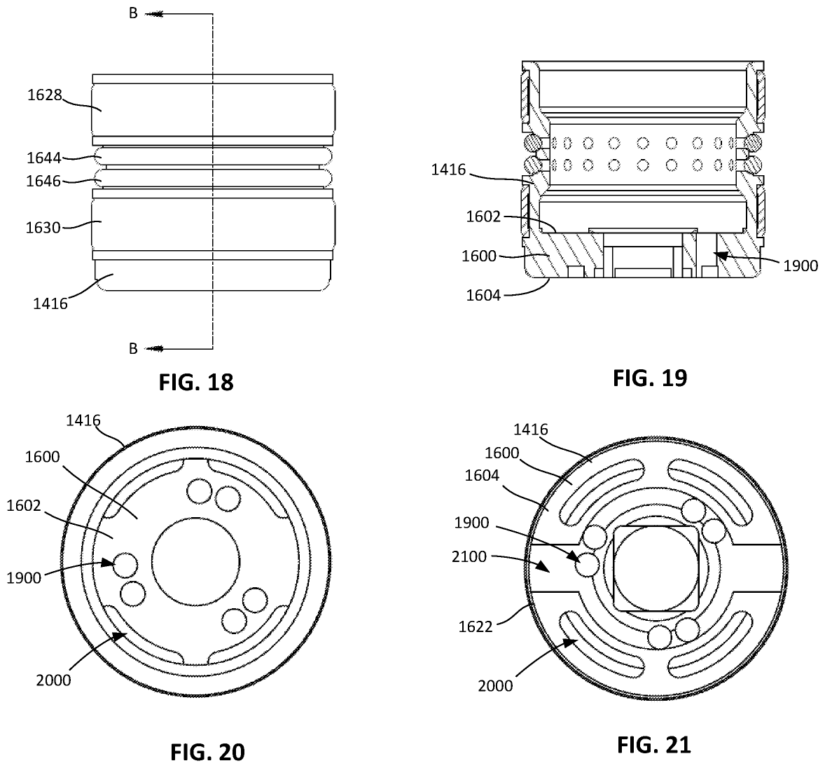

FIG. 17 is an exploded view of the piston 1416, the first and second seals 1628, 1630, and the first and second rings 1644, 1646. FIG. 18 is a side view of the piston 1416 with the first and second seals 1628, 1630 and the first and second rings 1644, 1646 on the piston 1416. FIG. 19 is a cross-sectional view of the piston 1416 taken along line B-B of FIG. 18. FIG. 20 is a top view of the piston 1416 and FIG. 21 is a top view of the piston 1416. As shown in FIGS. 19, 20, and 21, the disc 1600 defines a plurality of rebound channels 1900 (one of which is referenced in each of FIGS. 19, 20, and 21) extending through the disc 1600 between the first side 1602 and the second side 1604. The disc 1600 may have any number of rebound channels 1900 (e.g., one, two, three, etc.). As shown in FIG. 21, the second side 1604 defines a recess or slot 2100 that extends from the outer surface 1622 to the rebound channels 1900. As shown in FIGS. 20 and 21, the disc 1600 also defines a plurality of compression channels 2000 (one of which is referenced in FIGS. 20 and 21) extending through the disc 1600 between the first side 1602 and the second side 1604. The disc 1600 may have any number of compression channels 2000 (e.g., one, two, three, etc.). When the damper member 1414 is assembled, the rebound shim stack 1616 (FIG. 16) is disposed on the first side 1602 of the disc 1600 and covers the rebound channels 1900, but not the compression channels 2000. Further, when the damper member 1414 is assembled, the compression shim stack 1618 (FIG. 16) is disposed on the second side 1604 of the disc 1600 and covers the compression channels 2000, but fluid can still flowthrough the slot 2100 (from the outer surface 1622) and into the compression channels 2000. Therefore, the rebound shim stack 1616 and the compression shim stack 1618 form check valves.

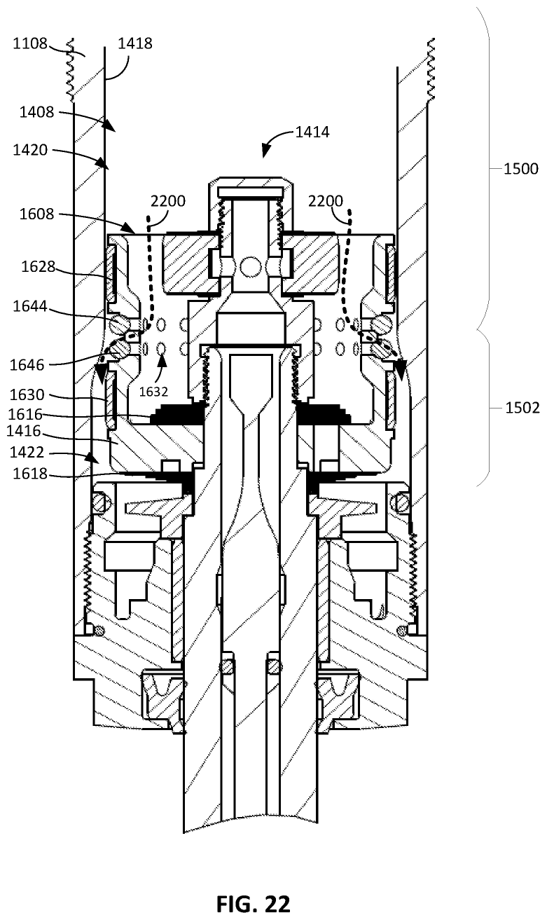

FIG. 22 illustrates a first compression flow path 2200 (shown as dotted lines) along which fluid flows during a first portion of the travel of the damper member 1414 during a compression stroke. The first compression flow path 2200 defines a flow path across the damper member 1414 from the first chamber 1420 to the second chamber 1422. In FIG. 22 the damper member 1414 is in the top-out position. In this position, the first seal 1628 is sealingly engaged with the inner surface 1418 of the damper body 1108 along the first section 1500 of the chamber 1408. However, because the second section 1502 has a larger cross-sectional area (e.g., diameter), the second seal 1630 is spaced apart from (not engaged with) the inner surface 1418 along the second section 1502 of the chamber 1408. During a compression stroke, the damper member 1414 is moved upward in the chamber 1408, which increases the pressure in the first chamber 1420 and decrease the pressure in the second chamber 1422. The pressure differential between the first and second chambers 1420, 1422 causes the rings 1644, 1646 to expand (e.g., exceeds the cracking pressure of the rings 1644, 1646), so that the fluid can flow past or around the rings 1644, 1646. This creates a flow path for the fluid to flow through the radial openings 1632 (one of which is referenced in FIG. 22) from the first chamber 1420 to the second chamber 1422. In particular, as the damper member 1414 is moved upward, fluid from the first chamber 1420 flows into the cavity 1608 in the piston 1416, through the radial openings 1632, around the rings 1644, 1646, and between the second seal 1630 and the inner surface 1418 into the second chamber 1422. The first and second rings 1644, 1646 form check valves. Therefore, the radial openings 1632 correspond to or form the bypass compression port 314 disclosed in connection with the damper 200 in FIG. 3, and the rings 1644, 1646 correspond to or form the bypass compression valve 316 disclosed in connection with the damper 200 in FIG. 3. During this first portion of travel, the compression shim stack 1618 remains closed. The cracking pressure of the rings 1644, 1646 is less than the cracking pressure of the compression shim stack 1618. In other words, the pressure differential needed to open or expand the rings 1644, 1646 (e.g., the cracking pressure) is less than the pressure differential needed to open the compression shim stack 1618. Therefore, the fluid flow bypasses the compression shim stack 1616 during the initial part of the compression stroke. This enables the damper member 1414 to compress more quickly. As disclosed above, the piston 1416 has two sets of radial openings 1632 that are radially spaced apart. The first (top) set of the radial openings 1632 are covered by the first ring 1644 and the second (lower) set are covered by the second ring 1646. In some examples, having two sets of radial openings increases flow through the piston 1416. Additionally, the axial spacing helps provide a smooth transition from one flow path to another flow path by closing/opening one ring 1644, 1646 at a time. During a compression stroke, the rebound shim stack 1616 remains closed.

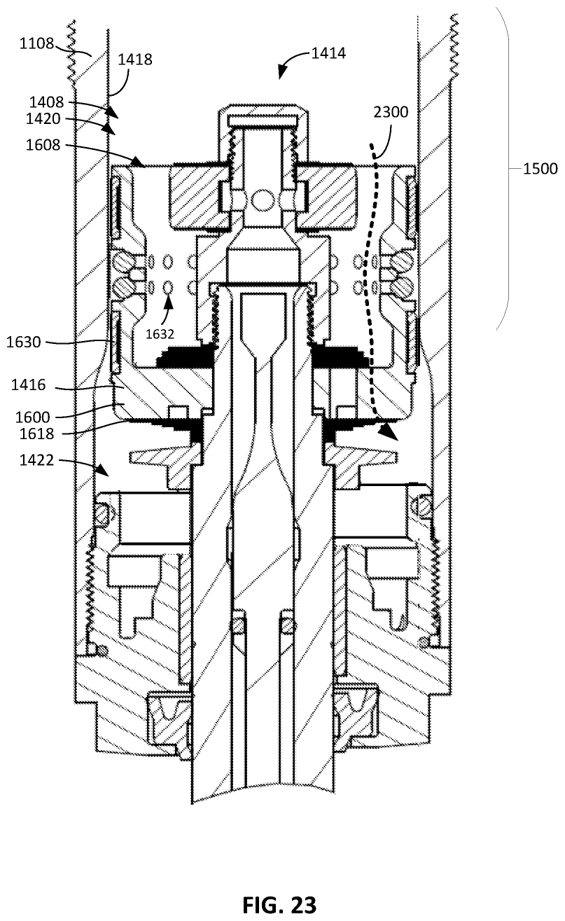

Once the damper member 1414 reaches a certain position during the compression stroke, the first compression flow path 2200 is blocked and fluid flows along a second compression flow path. For example, as shown in FIG. 23, the damper member 1414 has moved upward during the compression stroke. In the position shown in FIG. 23, the second seal 1630 is sealingly engaged with the inner surface 1418 of the damper body 1108 along the first section 1500 of the chamber 1408. This blocks or prevents fluid flow through the radial openings 1632 (one of which is referenced in FIG. 23) from the first chamber 1420 to the second chamber 1422. Instead, the pressure differential in the first and second chambers 1420, 1422 causes the compression shim stack 1618 to bend open, which enables fluid flow along a second compression flow path 2300 (shown as a dotted line). In particular, fluid from the first chamber 1420 flows into the cavity 1608 in the piston 1416, through the compression channels 2000 (FIGS. 20 and 21) in the disc 1600 of the piston 1416, past the compression shim stack 1618, and into the second chamber 1422. Therefore, the cavity 1608 and the compression channels 2000 correspond to or form the primary compression port 306 disclosed in connection with the damper 200 in FIG. 3, and the compression shim stack 1618 corresponds to or forms the primary compression check 308 disclosed in connection with the damper 200 of FIG. 3. The flow of fluid through the piston 1416 and across the compression shim stack 1618 dampens or slows the movement of the fluid, thereby dampening movement of the shock absorber 1100 (FIG. 11) during compression. The fluid continues to flow along the second compression flow path 2300 as the damper member 1414 moves upward in the damper body 1108 during the compression stroke.

The first seal 1628 is the primary seal that separates the first and second chambers 1420, 1422. The second seal 1630 is used for controlling compression damping by opening or closing the first compression flow path 2200. In some examples, the second seal 1630 is smaller than the first seal 1628 and has less sealing engagement with the inner surface 1418. This reduces (e.g., minimizes) any friction caused by the second seal 1630. Any leak past the second seal 1630 is stopped by the first seal 1628. However, in other examples, the second seal 1630 may be the same size as the first seal 1628.

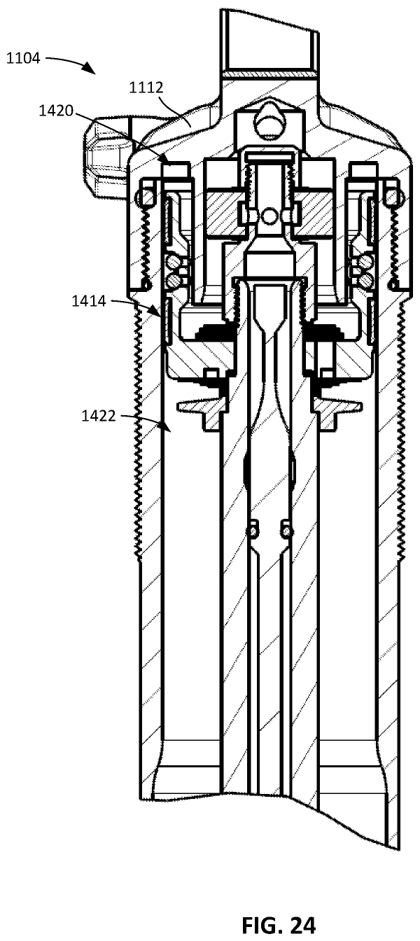

In some examples, the damper member 1414 reaches a bottom-out position, which is shown in FIG. 24. In some examples, the bottom-out position occurs when the spring 1102 (FIG. 11) is fully compressed. Therefore, the first portion of travel of the damper member 1414 corresponds to movement of the damper member 1414 from the top-out position shown in FIG. 22 to the position shown in FIG. 23, and the second portion of travel corresponds to movement of the damper member 1414 from the position shown in FIG. 23 to the bottom-out position shown in FIG. 24 (or any position where the damper member 1414 stops before rebound). During the first portion of travel of the damper member 1414, fluid flows along the first compression flow path 2200, and during the second portion of the damper member 1414, fluid flows along the second compression flow path 2300. During the first portion of travel, the damper 1104 provides less (e.g., minimal) resistance or damping, whereas during the second portion of travel, the damper 1104 provides more resistance or damping. The distance or length of the first and second portions can be configured based the length of the first and second sections 1500, 1502, the size of the piston 1416, the location of the second seal 1630, and/or one or more other parameters.

When the compressive force is removed, the shock absorber 1100 rebounds. As such, the damper member 1414 moves away from the cap 1112. This increases the pressure of the fluid in the second chamber 1422 and decreases the pressure of the fluid in the first chamber 1420. The damper member 1414 defines one or more rebound flow paths.

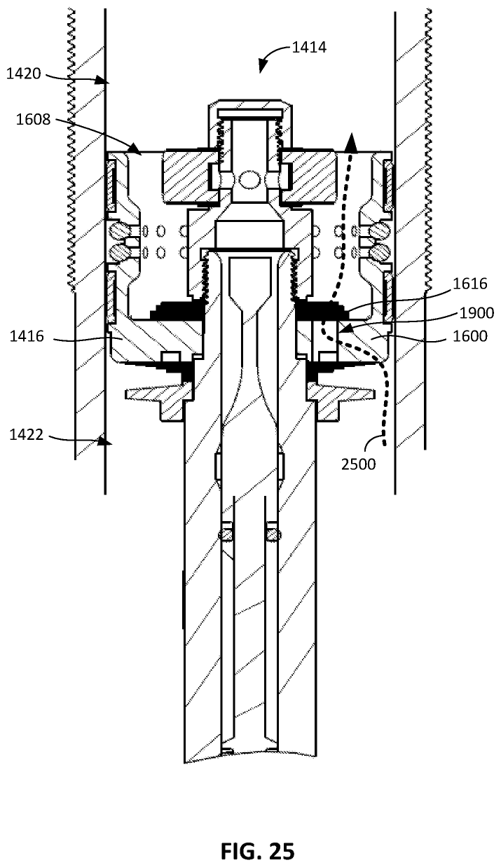

FIG. 25 illustrates an example rebound flow path 2500 (shown as a dotted line) along which fluid flows across the damper member 1414 during a rebound stroke. The pressure differential between the first and second chambers 1420, 1422 causes the rebound shim stack 1616 to bend open, which enables fluid flow along the rebound flow path 2500. In particular, fluid flows from the second chamber 1422, through the slot 2100 (FIG. 21) and through the rebound channels 1900 in the disc 1600 of the piston 1416, past the rebound shim stack 1616, through the cavity 1608 of the piston 1416, and into the first chamber 1420. Therefore, the slot 2100, the rebound channels 1900, and the cavity 1608 correspond to or form the rebound port 310 disclosed in connection with the damper 200 in FIG. 3, and the rebound shim stack 1616 corresponds to or forms the rebound valve 312 disclosed in connection with the damper 200 of FIG. 3. The flow of fluid through the piston 1416 and across the rebound shim stack 1616 dampens or slows the movement of the fluid, thereby dampening movement of the shock absorber 1100 (FIG. 11) during rebound. During rebound, fluid flow is blocked from flowing along the first compression flow path 2200 by the rings 1644, 1646 and fluid flow is blocked from flowing along the second compression flow path 2300 by the compression shim stack 1618.

While in the example of FIGS. 14-25 the damper member 1414 includes the rings 1644, 1646 (e.g., o-rings) aligned with the radial openings 1632 to form the bypass compression valve 316, in other examples, the damper member 1414 can include other configurations of radial openings and/or other structures for regulating the flow of fluid through the radial openings. For example, FIG. 26 is a cross-sectional view of the damper member 1414 in the damper body 1108. As disclosed above, the piston 1416 of the damper member 1414 includes the wall 1606, which forms the cavity 1608 with fluid from the first chamber 1420. In this example, the piston 1416 has a different arrangement of radial openings than the example of FIGS. 14-25. In particular, in the example shown in FIG. 26, the piston 1416 has a first radial opening 2600 and a second radial opening 2602 that extend through the wall 1606 of the piston 1416 between the inner surface 1634 and the outer surface 1622 of the wall 1606. The first and second radial openings 2600, 2604 enable fluid flow from the first chamber 1420 to the second chamber 1422 during the first portion of travel of the damper member 1414 during a compression stroke. In the illustrated example of FIG. 26, the damper member 1414 includes a first radial flow shim 2604 disposed on the outer surface 1622 of the wall 1606 over (e.g., covering, radially aligned with) the first radial opening 2600. The damper member 1414 also includes a second radial flow shim 2606 disposed on the outer surface 1622 of the wall 1606 over the second radial opening 2602. The first and second radial flow shims 2604, 2606 are flexible or bendable, such that they can be flexed or bent away from the outer surface 1622 of the wall 1606. The first and second radial flow shims 2604, 2606 may also be referred to as flappers or leaf springs. In some examples, the first and second radial flow shims 2604, 2606 are coupled to the wall 1606 of the piston 1416 via threaded fasteners (e.g., bolts, screws).

The first and second radial openings 2600, 2602 operate similar to the radial openings 1632 disclosed above. For example, FIG. 26 shows an example compression flow path 2608 (shown as dotted lines) along which fluid flows during the first portion of the travel of the damper member 1414 during a compression stroke. The cracking pressure of the first and second radial flow shims 2604, 2606 is less than the compression shim stack 1618. Therefore, during the first portion of the travel, the pressure differential between the first and second chambers 1420, 1422 causes the first and second radial flow shims 2604, 2606 to bend or flex outward, i.e., away from the outer surface 1622 of the wall 1606 of the piston 1416. This enables fluid to flow through the first and second radial openings 2600, 2602 from the first chamber 1420 to the second chamber 1422. When the pressure differential is reduced (or the second compression flow path 2300 (FIG. 23) is open during the second portion of travel), the first and second radial flow shims 2604, 2606 flex back into engagement with the outer surface 1622 of the piston 1416 to block the first and second radial openings 2600, 2602. As such, the first and second radial flow shims 2604, 2606 form check valves that allow fluid flow in one direction but block fluid flow in the opposite direction. The first and second radial openings 2600, 2602 correspond to or form the bypass compression port 314 disclosed in connection with the damper 200 in FIG. 3, and the first and second radial flow shims 2604, 2606 correspond to or form the bypass compression valve 316 disclosed in connection with the damper 200 in FIG. 3. The example radial flow shims 2604, 2606 are advantageous because they have a relatively constant spring rate and, thus, enable fluid to flow more linearly or consistently. Further, the flexibility of the radial flow shims 2604, 2606 is less susceptible to temperature changes in the fluid. The rest of the damper member 1414 is the same as disclosed above, and the second compression flow path 2300 (FIG. 23) and the rebound flow path 2500 (FIG. 25) operate the same as previously disclosed. Thus, the related description is not repeated herein.

While in this example the piston 1416 includes two radial openings, in other examples, the piston 1416 may include only one radial opening (e.g., only the first radial opening 2600) or more than two radial openings (e.g., three, four, five, etc.). Further, in this example, the first and second radial openings 2600, 2602 are on opposite sides of the piston 1416. In particular, the first and second radial openings 2600, 2602 are aligned with an axis 2610 (e.g., a radial axis) that is perpendicular to the axis of movement 1640 of the damper member 1414. However, in other examples, the first and second radial openings 2600, 2602 can be located in other positions relative to each other.

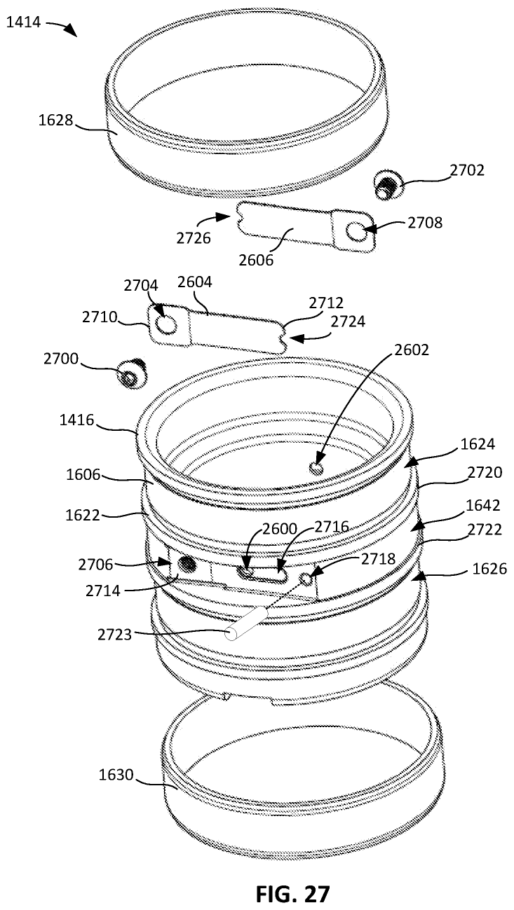

FIG. 27 is an exploded view of the damper member 1414 of FIG. 26 showing the piston 1416, the first and second seals 1628, 1630, and the first and second radial flow shims 2604, 2606. The other components of the damper member 1414 are not shown. FIG. 27 shows the radial openings 2600, 2602 in the wall 1606 of the piston 1416. When the damper member 1414 is assembled, the first and second radial flow shims 2604, 2606 are coupled to the wall 1606 of the piston 1416 and cover the first and second radial openings 2600, 2602, respectively. In this example, the first and second radial flow shims 2604, 2606 are coupled to the wall 1606 of the piston 1416 via first and second threaded fasteners 2700, 2702 (e.g., bolts, cap screws, etc.), respectively. The first radial flow shim 2604 has a first opening 2704 and the piston 1416 has a first threaded opening 2706 for the first threaded fastener 2700. When the damper member 1414 is assembled, the first threaded fastener 2700 extends through the first opening 2704 and is screwed into the first threaded opening 2706 to couple the first radial flow shim 2604 to the wall 1606. The second radial flow shim 2606 has a second opening 2708 and the piston 1416 has a threaded opening for the second threaded fastener 2702, shown in FIG. 30.

In this example, the first and second radial flow shims 2604, 2606 have a flat rectangular shape. When the first and second radial flow shims 2604, 2606 are coupled to the piston 1416, the first and second radial flow shims 2604, 2606 are oriented perpendicular to a radial line that extends from the axis of movement 1640 (FIG. 26) of the damper member 1414. The first and second radial flow shims 2604, 2606 are flexible or bendable. As such, when a certain cracking pressure is reached, a portion of the first and second radial flow shims 2604, 2606 flex or bend away from the outer surface 1622 of the piston 1416 to enable fluid flow through the first and second radial openings 2600, 2602. In some examples, the first and second radial flow shims 2604, 2606 are constructed of metal (e.g., stainless steel, aluminum, etc.). For example, the first and second radial flow shims 2604, 2606 can be constructed (e.g., cut, stamped, etc.) of sheet metal. In other examples, the first and second radial flow shims 2604, 2606 can be constructed of other materials (e.g., plastic, rubber). In the illustrated example, the first radial flow shim 2604 has a first end 2710 and a second end 2712 opposite the first end 2710. In this example, the first opening 2704 is at or near the first end 2710. Therefore, the first radial flow shim 2604 is coupled to the wall 1606 of the piston 1416 closer to the first end 2710. The second end 2712 is free (e.g., cantilever) and not coupled to the wall 1606. This enables second end 2712 to be moveable (e.g., flexible, bendable) away from the outer surface 1622 of the wall 1606. The second radial flow shim 2606 is similarly coupled near to the piston 1416.

As disclosed above, the piston 1416 has the recess 1642 between the first and second seal grooves 1624, 1626. When the damper member 1414 is assembled, the first and second radial flow shims 2604, 2606 are disposed in the recess 1642. The first and second radial openings 2600, 2602 extend through the recess 1642 and, thus, are axially spaced between the first and second seals 1628, 1630. In this example, the outer surface 1622 of the wall 1606 in the recess 1642 has a first flattened surface 2714. The first radial opening 2600 extends through the first flattened surface 2714. When the damper member 1414 is assembled, the first radial flow shim 2604 is coupled to the first flattened surface 2714 by the first threaded fastener 2700. As such, the first radial flow shim 2604 lays flat on the first flattened surface 2714 of the piston 1416 and covers the first radial opening 2600. When the cracking pressure of the first radial flow shim 2604 is reached, the pressure causes the first radial flow shim 2604 to flex or bend outward, away from the first flattened surface 2714. This enables the fluid to flow through the first radial opening 2600 between the first and second chambers 1420, 1422 (FIG. 26). When the pressure differential is reduced below a certain point, the first radial flow shim 2604 flexes back into engagement with the first flattened surface 2714 to block fluid flow through the first radial opening 2600. The piston 1416 has a similar flattened surface on the opposite side for the second radial flow shim 2606, shown in FIGS. 29 and 30.

As shown in FIG. 27, the piston 1416 has a recess 2716 (e.g., an oval-shaped recess) extending into the first flattened surface 2714 at a location of the first radial opening 2600. Said another way, the recess 2716 overlaps with the first radial opening 2600. As such, fluid from the first chamber 1420 (FIG. 26) fills the recess 2716. This enables the active pressure area on the backside of the first radial flow shim 2604 to be larger than the first radial opening 2600. This allows for the first radial flow shim 2604 to open more easily, while still allowing the first radial opening 2600 to remain relatively small (e.g., have a small diameter).

In the illustrated example of FIG. 27, the piston 1416 has a first bore 2718 extending into the first flattened surface 2710. The first bore 2718 can be used for aligning and/or centering the first radial flow shim 2604 in the recess 1642 during assembly. The recess 1642 is defined between two ribs 2720, 2722. During assembly, a pin 2723 can be partially inserted into the first bore 2718. As shown in FIG. 27, the first radial flow shim 2604 has a notch 2724. When the first radial flow shim 2604 is placed against the first flattened surface 2714 during assembly, the first notch 2724 self-locates on the pin 2723. This helps center the first radial flow shim 2604 in the recess 1642 such that the first radial flow shim 2604 is spaced apart from the ribs 2720, 272. This ensures the first radial flow shim 2604 does not rub on the ribs 2720, 2722 when flexing open and closed. Once the first radial flow shim 2604 is aligned or centered between the ribs 2720, 2722, the first threaded fastener 2700 can be tightened to secure the first radial flow shim 2604 to the piston 1416 and then the pin 2723 can be removed from the first bore 2718. As shown in FIG. 27, the second radial flow shim 2606 similarly includes a notch 2726 for the same purpose.

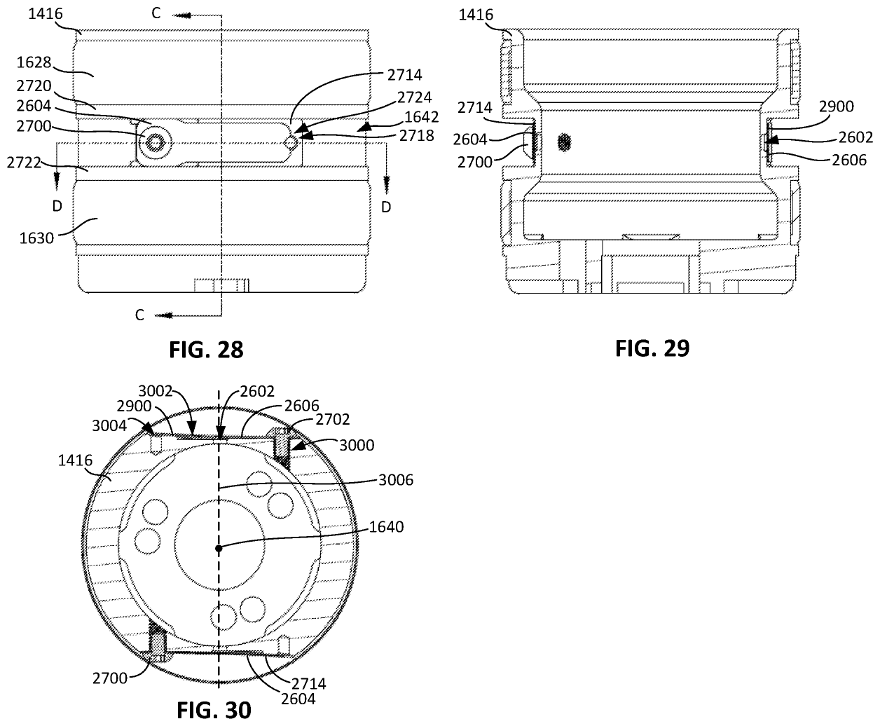

FIG. 28 is a side view of the piston 1416 from FIGS. 26 and 27 with the first and second seals 1628, 1630 and the first and second radial flow shims 2604, 2606 (the second radial flow shim 2606 is on the opposite side of the piston 1416) installed on the piston 1416. FIG. 29 is a cross-sectional view taken along lines C-C of FIG. 28. FIG. 30 is a cross-sectional view taken along lines D-D of FIG. 28. As shown in FIGS. 28-30, the first radial flow shim 2604 is coupled to the first flattened surface 2714 by the first threaded fastener 2700. Also, as shown in FIG. 28, the notch 2724 is aligned with the first bore 2718. As disclosed above, the first bore 2718 can be used during assembly to center the first radial flow shim 2604 in the recess 1642. As shown in FIG. 28, there is a clearance between the first radial flow shim 2604 (or at least a portion of the first radial flow shim 2604) and the ribs 2720, 2722.

As shown in the illustrated example of FIGS. 29 and 30, the piston 1416 has a second flattened surface 2900 opposite the first flattened surface 2714. The second radial opening 2602 extends through the second flattened surface 2900. The piston 1416 has a second threaded opening 3000 (FIG. 30) for the second threaded fastener 2702. The second radial flow shim 2606 is coupled to the second flattened surface 2900 by the second threaded fastener 2702. As shown in FIG. 30, the second flattened surface 2900 also has a second recess 3002 and a second bore 3004, which function the same as the first recess 2716 and the first bore 2718 disclosed above and are not repeated herein.

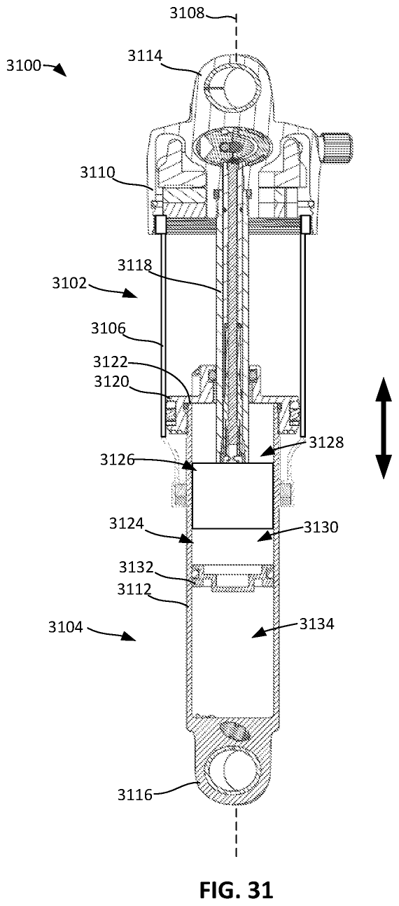

As disclosed above, the first and second radial flow shims 2604, 2606 have a flat rectangular shape. As shown in FIG. 30, the first and second radial flow shims 2604, 2606 are oriented perpendicular to a radial line 3006 that extends from the axis of movement 1640 (extending into the page) of the damper member 1414 (FIG. 26). In other examples, the first and second radial flow shims 2604, 2606 can be shaped differently. As disclosed above, in some examples a shock absorber can include an air can as a spring instead of a coil spring. The example dampers disclosed herein can be implemented in shock absorbers having such an air can. For example, FIG. 31 is a cross-sectional view of an example shock absorber 3100 that can be implemented as the shock absorber 136 and used on the bicycle 100 of FIG. 1. In the illustrated example, the shock absorber 3100 includes an integrated spring 3102 and damper 3104. In the illustrated example, the spring 3102 is implemented as an air can 3106. The spring 3102 and the damper 3104 are configured in a telescoping arrangement and aligned along an axis 3108.

In the illustrated example, the shock absorber 3100 includes a cap 3110, which forms a top (or end) of the air can 3106. The damper 3104 includes a damper body 3112. The cap 3110 and the damper body 3112 include respective first and second attachment portions 3114, 3116 (e.g., eyelets) at distal ends for connecting the shock absorber 3100 between two components of a bicycle, such as two points on the frame 102 (FIG. 1) of the bicycle 100 (FIG. 1), the frame 102 and the rocker 140 (FIG. 1) connected to the rear wheel 106 (FIG. 1) of the bicycle 100, and/or another intermediate part or component. The air can 3106 and the damper body 3112 are configured in a telescopic arrangement. In particular, in this example, the damper body 3112 is moveable into and out of the air can 3106 as shown by the double-sided arrow. For example, during compression, the first and second attachment portions 3114, 3116 are pushed toward each other, which moves the damper body 3112 into the air can 3106 (or moves the air can 3106 over the damper body 3112). Conversely, during rebound, the first and second attachment portions 3114, 3116 are pushed (or and/or pulled) apart at least in part by force from the spring 3102, which moves the damper body 3112 out of the air can 3106.

In the illustrated example, the damper 3104 includes a shaft 3118 that is coupled to and extends from the cap 3110. A fixed piston 3120 is coupled (e.g., via threaded engagement) to a top end 3122 of the damper body 3112. In the illustrated example, the damper body 3112 defines a chamber 3124. The shaft 3118 extends through the fixed piston 3120 and into the chamber 3124. The shaft 3118 slides into and out of the damper body 3112 through the fixed piston 3120 as the shock absorber 3100 compresses and rebounds. The fixed piston 3120 is slidable within the air can 3106. During compression (when the air can 3106 and the damper body 3112 move toward each other), the fixed piston 3120 is pushed into the air can 3106, which compresses a gas (e.g., air) within the air can 3106. After the compressive force is removed, the compressed gas in the air can 3106 acts against the fixed piston 3120 and pushes the fixed piston 3120 (and, thus, the damper body 3112) outward from the air can 3106. In other examples, the air can 3106 can be filled with other types of fluids (e.g., oil).

As shown in FIG. 31, the damper 3104 includes a damper member 3126 coupled to a distal end of the shaft 3118. The damper member 3126 divides the chamber 3124 into a first chamber 3128 and a second chamber 3130. In this example, the damper 3104 includes an internal floating piston (IFP) 3132 that is slidably disposed within the damper body 3112. The IFP 3132 separates the fluid in the second chamber 3130 from a pneumatic pressure chamber 3134 having a pneumatic fluid, such as air or nitrogen. The damper 3104 can be implemented as any of the example dampers 200, 1104 disclosed herein. The example dampers disclosed herein provide varying levels of damping during compression depending on the position of the damper member. This enables the damper to compress more quickly and thereby absorb shocks and vibrations.

While the example dampers disclosed herein are described in connection with shock absorbers having inline dampers and springs, the example dampers disclosed herein can also be used in other types of suspension components. For example, any of the example dampers disclosed herein can be implemented in a front fork of a bicycle. For instance, the damper can be integrated into one of the legs of the front fork.

Example systems, apparatus, and articles of manufacture for bicycles (and/or other vehicles) are disclosed herein. Examples and combinations of examples disclosed herein include the following:

Example 1 is a damper for a bicycle suspension component. The damper comprises a damper body defining a chamber, a shaft extending into the damper body, and a damper member disposed in the chamber and coupled to the shaft. The damper member divides the chamber into a first chamber and a second chamber. The damper member includes a piston having a first compression port and a bypass compression port. The damper member includes a first valve to control fluid flow through the first compression port and a second valve to control fluid flow through the bypass compression port. During a first portion of travel of the damper member during a compression stroke, the second valve is to open to enable fluid flow through the bypass compression port from the first chamber to the second chamber, and, during a second portion of travel of the damper member during the compression stroke, the first valve is to open to enable fluid flow through the first compression port from the first chamber to the second chamber.

Example 2 includes the damper of Example 1, wherein the second valve has a lower cracking pressure than the first valve.

Example 3 includes the damper of Examples 1 or 2, wherein the first and second valves are check valves.

Example 4 includes the damper of any of Examples 1-3, wherein, the first valve is to remain closed during the first portion of travel of the damper member, and the second valve is to remain closed during the second portion of travel of the damper member.

Example 5 includes the damper of any of Examples 1-4, wherein at least a portion of an outer side surface of the piston is sealingly engaged with an inner surface of the damper body to limit fluid flow between the piston and the inner surface of the damper body.

Example 6 includes the damper of Example 5, wherein the first compression port extends between a first end of the piston and a second end of the piston opposite the first end, and wherein the bypass compression port extending between the first compression port and the outer side surface of the piston.

Example 7 includes the damper of Example 6, wherein the chamber of the damper body has a first section with a first cross-sectional area and a second section with a second cross-sectional area that is greater than the first cross-sectional area.

Example 8 includes the damper of Example 7, wherein, during the first portion of the travel of the damper member, the bypass compression port is aligned with the second section, and wherein, during the second portion of the travel of the damper, the bypass compression port is aligned with the second section and blocked by the inner surface of the damper member.

Example 9 includes the damper of Examples 7 or 8, further including a sleeve in the damper body, the sleeve forming the inner surface of the damper body along the first section, wherein the sleeve is moveable to adjust a length of the first section and a length of the second section.

Example 10 includes the damper of any of Examples 1-9, wherein the piston has a rebound port, wherein the damper member includes a third valve to control fluid flow through the rebound port, and wherein, during a rebound stroke, the third valve is to open and the first and second valves are to close.

Example 11 is damper for a bicycle suspension component. The damper comprises a damper body defining a chamber, the chamber having a first section with a first cross-sectional area and a second section with a second cross-sectional area greater than the first cross-sectional area, a shaft extending into the damper body, a damper member disposed in the chamber and coupled to the shaft, the damper member dividing the chamber into a first chamber and a second chamber, the damper member including a piston having a plurality of radial openings, a first seal around the piston, and a second seal around the piston, the radial openings axially spaced between the first and second seals. During a first portion of travel of the damper member during a compression stroke, the first seal is engaged with an inner surface of the damper body along the first section of the chamber and the second seal is spaced from the inner surface of the damper body along the second section of the chamber to enable fluid flow through the radial openings from the first chamber to the second chamber, and, during a second portion of travel of the damper member during the compression stroke, the first and second seals are engaged with the inner surface along the first section of the chamber to prevent fluid flow through the radial openings from the first chamber to the second chamber.

Example 12 includes the damper of Example 11, wherein the radial openings are aligned along axes that are radial relative to an axis of movement of the damper member.

Example 13 includes the damper of Examples 11 or 12, wherein the damper member includes a ring disposed around the piston and aligned with the radial openings

Example 14 includes the damper of Example 13, wherein the ring is expandable.

Example 15 includes the damper of any of Examples 11-14, wherein the radial openings are arranged in a first set and a second set that are axially spaced apart.

Example 16 includes the damper of any of Examples 11-15, wherein the piston includes a disc defining a compression channel, wherein the damper member includes a compression shim stack covering the compression channel.

Example 17 includes the damper of Example 16, wherein a cracking pressure of the ring is less than the compression shim stack.

Example 18 is a damper for a bicycle suspension component. The damper comprises a damper body, a shaft extending into the damper body, a damper member disposed in the damper body and coupled to the shaft, the damper member including a piston sealingly engaged with an inner surface of the damper body to divide the damper body into a first chamber and a second chamber, first means for allowing fluid flow across the piston from the first chamber to the second chamber during a first portion of travel of the damper member during a compression stroke, and second means for allowing fluid flow across the piston from the first chamber to the second chamber during a second portion of travel of the damper member during the compression stroke.

Example 19 includes the damper of Example 18, wherein the first means provides less fluid resistance than the second means.

Example 20 includes the damper of Examples 18 or 19, further including means for controlling a length of the first portion of travel of the damper member.

Example 21 is a damper for a bicycle suspension component. The damper comprises a damper body defining a chamber, a shaft extending into the damper body, and a damper member disposed in the chamber and coupled to the shaft. The damper member divides the chamber into a first chamber and a second chamber. The damper member includes a piston including a disc and a wall extending from the disc. A portion of an outer surface of the wall is sealed with an inner surface of the damper body. The piston has a radial opening extending through the wall. The damper member also includes a radial flow shim disposed on an outer surface of the wall of the piston over the radial opening. The radial flow shim is flexible such that during at least a portion of travel of the damper member during a compression stroke, a portion of the radial flow shim is flexed away from the outer surface of the wall to enable fluid flow through the radial opening from the first chamber to the second chamber.

Example 22 includes the damper of Example 21, wherein the outer surface of the wall has a flattened surface, and wherein the radial opening extends through the flattened surface.

Example 23 includes the damper of Example 22, wherein the radial flow shim is coupled to the flattened surface by a threaded fastener.

Example 24 includes the damper of Examples 22 or 23, wherein the radial flow shim has a flat rectangular shape.

Example 25 includes the damper of Example 24, wherein the radial flow shim is constructed of sheet metal.

Example 26 includes the damper of any of Examples 22-25, wherein the piston has a recess extending into the flattened surface at a location of the radial opening.

Example 27 includes the damper of any of Examples 22-26, wherein the piston has a bore extending into the flattened surface, and wherein the radial flow shim has a notch aligned with the bore.

Example 28 includes the damper of any of Examples 21-27, wherein the radial opening is a first radial opening and the radial flow shim is a first radial flow shim. The piston has a second radial opening extending through the wall, and the damper member includes a second radial flow shim disposed on the outer surface of the wall of the piston and over the second radial opening.

Example 29 includes the damper of Example 28, wherein the first and second radial openings are aligned along an axis that is perpendicular to an axis of movement of the damper member.

Example 30 includes the damper of any of Examples 21-29, wherein the damper member includes: a first seal around the piston; and a second seal around the piston, the radial opening axially spaced between the first and second seals.

Example 31 includes the damper of any of Examples 21-30, wherein the chamber has a first section with a first cross-sectional area and a second section with a second cross-sectional area greater than the first cross-sectional area.

Example 32 includes the damper of any of Examples 21-31, wherein the disc defines a compression channel, and wherein the damper member includes a compression shim stack covering the compression channel.

Example 33 includes the damper of Example 22, wherein a cracking pressure of the radial flow shim is less than the compression shim stack.

Example 34 is a damper for a bicycle suspension component. The damper comprises a damper body defining a chamber, a shaft extending into the damper body, and a damper member disposed in the chamber. The damper member includes a piston including a wall forming a cavity. The piston has a radial opening extending through the wall between an inner surface of the wall and an outer surface of the wall. The damper member also includes a radial flow shim coupled to the wall and covering the opening. The radial flow shim is oriented perpendicular to a radial line extending from an axis of movement of the damper member.

Example 35 includes the damper of Example 34, wherein the radial flow shim has a first end and a second end opposite the first end. The radial flow shim is coupled to the wall of the piston closer to the first end such that the second end is moveable away from the outer surface of the wall.

Example 36 includes the damper of Example 35, wherein the radial flow shim has an opening, and wherein the radial flow shim is coupled to the wall via a threaded fastener extending through the opening in the radial flow shim.

Example 37 includes the damper of any of Examples 34-36, wherein the radial flow shim is constructed of sheet metal.

Example 38 includes the damper of any of Examples 34-37, wherein the outer surface of the piston has a recess defined between two ribs, and wherein the radial flow shim is disposed in the recess.

Example 39 includes the damper of Example 38, wherein the radial flow shim is spaced from the ribs.

Example 40 includes the damper of Examples 38 or 39, wherein the outer surface of the wall in the recess has a flattened surface, and wherein the radial flow shim is coupled to the flattened surface.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A damper for a bicycle suspension component, the damper comprising:
a damper body defining a chamber;
a shaft extending into the damper body; and
a damper member disposed in the chamber and coupled to the shaft, the damper member dividing the chamber into a first chamber and a second chamber, the damper member including:
a piston including a disc and a wall extending from the disc, wherein a portion of an outer surface of the wall is sealed with an inner surface of the damper body, the piston having a radial opening extending through the wall; and
a radial flow shim disposed on an outer surface of the wall of the piston over the radial opening, wherein the radial flow shim is flexible such that during at least a portion of travel of the damper member during a compression stroke, a portion of the radial flow shim is flexed away from the outer surface of the wall to enable fluid flow through the radial opening from the first chamber to the second chamber.

2. The damper of claim 1, wherein the outer surface of the wall has a flattened surface, and wherein the radial opening extends through the flattened surface.

3. The damper of claim 2, wherein the radial flow shim is coupled to the flattened surface by a threaded fastener.

4. The damper of claim 2, wherein the radial flow shim has a flat rectangular shape.

5. The damper of claim 4, wherein the radial flow shim is constructed of sheet metal.

6. The damper of claim 2, wherein the piston has a recess extending into the flattened surface at a location of the radial opening.

7. The damper of claim 2, wherein the piston has a bore extending into the flattened surface, and wherein the radial flow shim has a notch aligned with the bore.

8. The damper of claim 1, wherein the radial opening is a first radial opening and the radial flow shim is a first radial flow shim, the piston having a second radial opening extending through the wall, the damper member including a second radial flow shim disposed on the outer surface of the wall of the piston and over the second radial opening.

9. The damper of claim 8, wherein the first and second radial openings are aligned along an axis that is perpendicular to an axis of movement of the damper member.

10. The damper of claim 1, wherein the damper member includes:
a first seal around the piston; and
a second seal around the piston, the radial opening axially spaced between the first and second seals.

11. The damper of claim 1, wherein the chamber has a first section with a first cross-sectional area and a second section with a second cross-sectional area greater than the first cross-sectional area.

12. The damper of claim 1, wherein the disc defines a compression channel, and wherein the damper member includes a compression shim stack covering the compression channel.

13. The damper of claim 12, wherein a cracking pressure of the radial flow shim is less than the compression shim stack.

14. A damper for a bicycle suspension component, the damper comprising:
a damper body defining a chamber;
a shaft extending into the damper body; and
a damper member disposed in the chamber, the damper member including:
a piston including a wall forming a cavity, the piston having a radial opening extending through the wall between an inner surface of the wall and an outer surface of the wall; and
a radial flow shim coupled to the wall and covering the opening, the radial flow shim oriented perpendicular to a radial line extending from an axis of movement of the damper member.

15. The damper of claim 14, wherein the radial flow shim has a first end and a second end opposite the first end, the radial flow shim coupled to the wall of the piston closer to the first end such that the second end is moveable away from the outer surface of the wall.

16. The damper of claim 15, wherein the radial flow shim has an opening, and wherein the radial flow shim is coupled to the wall via a threaded fastener extending through the opening in the radial flow shim.

17. The damper of claim 15, wherein the radial flow shim is constructed of sheet metal.

18. The damper of claim 14, wherein the outer surface of the piston has a recess defined between two ribs, and wherein the radial flow shim is disposed in the recess.

19. The damper of claim 18, wherein the radial flow shim is spaced from the ribs.

20. The damper of claim 18, wherein the outer surface of the wall in the recess has a flattened surface, and wherein the radial flow shim is coupled to the flattened surface.
